(19) United States
(12) Patent Application Publication
(10) Pub. No.: US 2025/0246817 A1
(43) Pub. Date: Jul. 31, 2025

(54) ELECTROMAGNETIC WAVE INPUT/OUTPUT ELEMENT AND ELECTROMAGNETIC WAVE INPUT/OUTPUT HEAD

(71) Applicant: National University Corporation Tokai National Higher Education and Research System, Nagoya-shi, Aichi (JP)

(72) Inventors: Shintaro HISATAKE, Nagoya-shi, Aichi (JP); Eito MIYAKE, Nagoya-shi, Aichi (JP)

(21) Appl. No.: 18/854,449

(22) PCT Filed: Mar. 22, 2023
(86) PCT No.: PCT/JP2023/011123

§ 371 Date: Oct. 4, 2024

(30) Foreign Application Priority Data
Apr. 8, 2022 (JP) 2022-064381

(51) Int. Cl. H01Q 13/24

(52) U.S. Cl. CPC H01Q 13/24

(57) ABSTRACT

An electromagnetic wave input/output element 1 attachable to a waveguide includes a dielectric three dimensional object 10 in the shape of a parallelepiped. The ratio b/c of the length b of the long side of the aperture surface of the parallelepiped and the length c of the side of the parallelepiped in the direction perpendicular to the aperture surface is smaller than 0.75.

### TECHNICAL FIELD

This disclosure relates to electromagnetic wave input/output elements and electromagnetic wave input/output heads.

### BACKGROUND ART

An antenna in the form of a dielectric cube, which is configured by plugging it into a waveguide, has been proposed for use in terahertz radio, see, for example, Non Patent Literature 1.

### RELATED-ART LITERATURE

### Non Patent Literature

Non Patent Literature 1: Yamada, Kazuki, et al. “Short-Range Wireless Transmission in the 300 GHz Band Using Low-Profile Wavelength-Scaled Dielectric Cuboid Antennas.” Frontiers in Communications and Networks 2.7 (2021) https://doi.org/10.3389/frcmn.2021.702968

### SUMMARY OF INVENTION

### Technical Problem

The dielectric cube described in Non Patent Literature 1 is specialized for antenna operation for utilization in the far field. This technology has disadvantages when used as an imaging element because of the characteristics such as splitting of the electromagnetic wave beam near the surface of the dielectric cube or limited range of resolution that is shorter than the wavelength (hereinafter referred to as “sub-wavelength”). In other words, the above-mentioned antennas have problems such as not being able to be used in close contact with the irradiation target and not having sufficient performance to achieve high-resolution imaging in the near field, e.g., the area from the surface of the dielectric cube to about two wavelengths.

The purpose of the present disclosure is to provide a high-resolution electromagnetic wave input/output element for imaging that can be used in the vicinity of an irradiation target.

### Solution to Problem

To solve the above problem, an electromagnetic wave input/output element attachable to a waveguide comprises a dielectric three dimensional object in the shape of a parallelepiped. The ratio b/c of the length b of the long side of the aperture surface of the parallelepiped and the length c of the side of the parallelepiped in the direction perpendicular to the aperture surface is smaller than 0.75.

In one embodiment, the parallelepiped may be rectangular parallelepiped.

In one embodiment, the ratio b/c may be 0.6 or less.

In one embodiment, the ratio b/c may be 0.4 or less.

In one embodiment, the dielectric three dimensional object may contain fluorinated resin in the material.

In one embodiment, the surface opposite the aperture surface may have a protrusion with a tapered tip for attachment to a waveguide.

In one embodiment, the electromagnetic wave may be microwave, millimeter wave or terahertz wave.

Another embodiment of the present disclosure is also an electromagnetic wave input/output element. This electromagnetic wave input/output element is attachable to a waveguide and comprises a three dimensional object in the shape of a parallelepiped with at least one of its sides truncated. The ratio b/c of the length b of the long side of the aperture surface of the three dimensional object and the length c of the side of the three dimensional object in the direction perpendicular to the aperture surface is smaller than 0.75.

Yet another embodiment of the present disclosure is an electromagnetic wave input/output head. This electromagnetic wave input/output head comprises a coupler having at least three ports and an electromagnetic wave input/output element forming a parallelepiped. The electromagnetic wave input/output element is attached to the first port of the coupler.

In one embodiment, the second port of the coupler may be connected to an output source of electromagnetic waves and the third port may be connected to the first electromagnetic wave detecting unit.

In one embodiment, the fourth port of the coupler may be connected to the second electromagnetic wave detecting unit.

In one embodiment, the first electromagnetic wave detecting unit and/or the second electromagnetic wave detecting unit may be connected to a cancellation system that cancels the output variation of the output source of the electromagnetic wave or an offset unit including a squaring system that superimposes the output of the electromagnetic wave output source.

Any combination of the above components, and any conversion of the expressions of the present disclosure between methods, devices, systems, recording media, computer programs, and the like, is also valid as an aspect of the present disclosure.

### Advantageous Effects of Invention

According to the present disclosure, it is possible to realize a high-resolution electromagnetic wave input/output element for imaging that can be used in the vicinity of an irradiation target.

### BRIEF DESCRIPTION OF DRAWINGS

FIG. 1 shows an oblique diagram of an electromagnetic wave input/output element according to the first embodiment.

FIG. 2 shows a schematic diagram of the electromagnetic wave input/output element of FIG. 1 inserted in a waveguide.

FIG. 3 shows a photograph of the electromagnetic wave input/output element of FIG. 1 inserted into a waveguide.

FIG. 4 shows the dependence of the FWHM of an electromagnetic wave beam generated by an electromagnetic wave input/output element with b/c=0.74 on the propagation distance in the E plane according to the embodiment.

FIG. 5 shows the dependence of the FWHM of an electromagnetic wave beam generated by an electromagnetic wave input/output element with b/c=0.74 on the propagation distance in the H plane according to the embodiment.

FIG. 6 shows the intensity distribution of the electric field in the E plane of an electromagnetic wave beam in the case of b/c=0.74 according to the embodiment.

FIG. 7 shows the phase distribution of the electric field in the E plane of an electromagnetic wave beam in the case of b/c=0.74 according to the embodiment.

FIG. 8 shows the intensity distribution of the electric field in the H plane of an electromagnetic wave beam in the case of b/c=0.74 according to the embodiment.

FIG. 9 shows the phase distribution of the electric field in the H plane of an electromagnetic wave beam in the case of b/c=0.74 according to the embodiment.

FIG. 10 shows the dependence of the FWHM of an electromagnetic wave beam generated by an electromagnetic wave input/output element with b/c=0.59 on the propagation distance in the E plane according to the embodiment.

FIG. 11 shows the dependence of the FWHM of an electromagnetic wave beam generated by an electromagnetic wave input/output element with b/c=0.59 on the propagation distance in the H plane according to the embodiment.

FIG. 12 shows the intensity distribution of the electric field in the E plane of an electromagnetic wave beam in the case of b/c=0.59 according to the embodiment.

FIG. 13 shows the phase distribution of the electric field in the E plane of an electromagnetic wave beam in the case of b/c=0.59 according to the embodiment.

FIG. 14 shows the intensity distribution of the electric field in the H plane of an electromagnetic wave beam in the case of b/c=0.59 according to the embodiment.

FIG. 15 shows the phase distribution of the electric field in the H plane of an electromagnetic wave beam in the case of b/c=0.74 according to the embodiment.

FIG. 16 shows the dependence of the FWHM of an electromagnetic wave beam generated by an electromagnetic wave input/output element with b/c=0.41 on the propagation distance in the E plane according to the embodiment.

FIG. 17 shows the dependence of the FWHM of an electromagnetic wave beam generated by an electromagnetic wave input/output element with b/c=0.41 on the propagation distance in the H plane according to the embodiment.

FIG. 18 shows the intensity distribution of the electric field in the E plane of an electromagnetic wave beam in the case of b/c=0.41 according to the embodiment.

FIG. 19 shows the phase distribution of the electric field in the E plane of an electromagnetic wave beam in the case of b/c=0.41 according to the embodiment.

FIG. 20 shows the intensity distribution of the electric field in the H plane of an electromagnetic wave beam in the case of b/c=0.41 according to the embodiment.

FIG. 21 shows the phase distribution of the electric field in the H plane of an electromagnetic wave beam in the case of b/c=0.41 according to the embodiment.

FIG. 22 shows the intensity distribution of the electric field in the E plane of an electromagnetic wave beam in the prior art.

FIG. 23 shows the phase distribution of the electric field in the E plane of an electromagnetic wave beam in the prior art.

FIG. 24 shows the intensity distribution of the electric field in the H plane of an electromagnetic wave beam in the prior art.

FIG. 25 shows the phase distribution of the electric field in the H plane of an electromagnetic wave beam in the prior art.

FIG. 26 shows the intensity distribution of the electric field in the E plane of an electromagnetic wave beam of the waveguide only.

FIG. 27 shows the phase distribution of the electric field in the E plane of an electromagnetic wave beam of the waveguide only.

FIG. 28 shows the intensity distribution of the electric field in the H plane of an electromagnetic wave beam of the waveguide only.

FIG. 29 shows the phase distribution of the electric field in the H plane of an electromagnetic wave beam of the waveguide only.

FIG. 30 shows a functional block diagram of an electromagnetic wave input/output element according to the second embodiment.

FIG. 31 shows a functional block diagram of another example of an electromagnetic wave input/output element according to the second embodiment.

FIG. 32 shows a functional block diagram of yet another example of an electromagnetic wave input/output element according to the second embodiment.

FIG. 33 shows a functional block diagram of yet another example of an electromagnetic wave input/output element according to the second embodiment.

FIG. 34 shows a photograph of the IC card used in the verification experiment.

FIG. 35 shows comparison of a photograph of imaging using the electromagnetic wave input/output element according to the embodiment and a photograph of imaging using an antenna of the prior art.

FIG. 36 shows the amplitude data in the A-A′ cross section in the lower part of FIG. 35.

FIG. 37 shows a photograph of a Japanese 1 yen coin used in the verification experiment.

FIG. 38 shows a photograph of phase imaging using the electromagnetic wave input/output element according to the embodiment.

FIG. 39 shows a photograph of amplitude imaging using the electromagnetic wave input/output element according to the embodiment.

FIG. 40 shows the depth data in the direction of depth in the cross-section B-B′ of FIG. 37, calculated from phase data.

FIG. 41 shows the dependence of the FWHM of an electromagnetic wave beam generated by PTFE and acrylic dielectric cubes on the propagation distance in the E plane.

FIG. 42 shows the dependence of the FWHM of an electromagnetic wave beam generated by PTFE and acrylic dielectric cubes on the propagation distance in the H plane.

FIG. 43 shows the intensity distribution of the electric field in the E plane of an electromagnetic wave beam generated by the acrylic dielectric cube.

FIG. 44 shows the phase distribution of the electric field in the E plane of an electromagnetic wave beam generated by the acrylic dielectric cube.

FIG. 45 shows the intensity distribution of the electric field in the H plane of an electromagnetic wave beam generated by the acrylic dielectric cube.

FIG. 46 shows the phase distribution of the electric field in the H plane of an electromagnetic wave beam generated by the acrylic dielectric cube.

### DESCRIPTION OF EMBODIMENTS

Before describing specific embodiments, we first describe the basic findings. Millimeter waves and terahertz waves have high permeability to plastics and clothing, while they have lower energy than X-rays and ultraviolet rays, therefore they cause less damage to the irradiated object. Moreover, the spectral absorption spectrum unique to the terahertz band, called the fingerprint spectrum, can be used to identify bio-related molecules and organic molecules. Thus, millimeter waves and terahertz waves are expected to be extremely useful for nondestructive testing.

Such nondestructive testing requires improved spatial resolution. However, in the case of imaging systems using image formation systems in free space, spatial resolution is limited by the diffraction limit. In particular, in imaging applications using the fingerprint spectrum, the frequency of the terahertz wave used for imaging is fixed according to the fingerprint spectrum. In this case, imaging probes that achieve sub-wavelength resolution are needed because the spatial resolution is limited by the wavelength.

Several sub-wavelength resolution imaging techniques in the millimeter wave and terahertz wave bands have been reported. In these prior arts, spatial resolution can be improved to about the size of the probe tip. However, for practical use, the distance between the sample and the probe must be actively controlled because the probe itself is broken when it touches the sample during inspection. In addition, due to the characteristics of near-field light, the distance between the sample and the probe must be kept as close as possible, e.g., to 3 μm. This is not suitable for nondestructive testing of objects with a certain distance in the depth direction, such as the contents of an envelope.

A “photonic jet” is known as a high intensity beam that exceeds the diffraction limit. A photonic jet is a phenomenon in which electromagnetic waves are generated behind a dielectric structure of wavelength-order size by irradiating the dielectric with electromagnetic waves. In recent years, applications of photonic jets have been attempted to improve imaging resolution in various domains, such as the optical, microwave, millimeter wave, and terahertz wave domains. However, prior arts that generate photonic jets by irradiating electromagnetic waves onto dielectric spheres, cylinders or cubes placed in free space have the following issues.
(1) To improve energy efficiency, a focusing optics system is required to irradiate a tightly focused beam onto a dielectric cube. However, its adjustment is very complicated.
(2) A focusing optics system using mirrors and lenses must have a distance of at least the focal length. This causes the entire imaging system to become larger.

The technique described in Non Patent Literature 1 uses photonic jets to achieve 300 GHz terahertz wireless communication using a compact and simple dielectric cube. However, this dielectric cube, when used as an imaging element, has issues such as splitting of the electromagnetic wave beam near the surface and narrow range in which sub-wavelength resolution can be achieved. In other words, this technology cannot achieve sufficient performance to realize high-resolution imaging in the near field, e.g., in the region from the surface of the dielectric cube to about two wavelengths.

### The First Embodiment

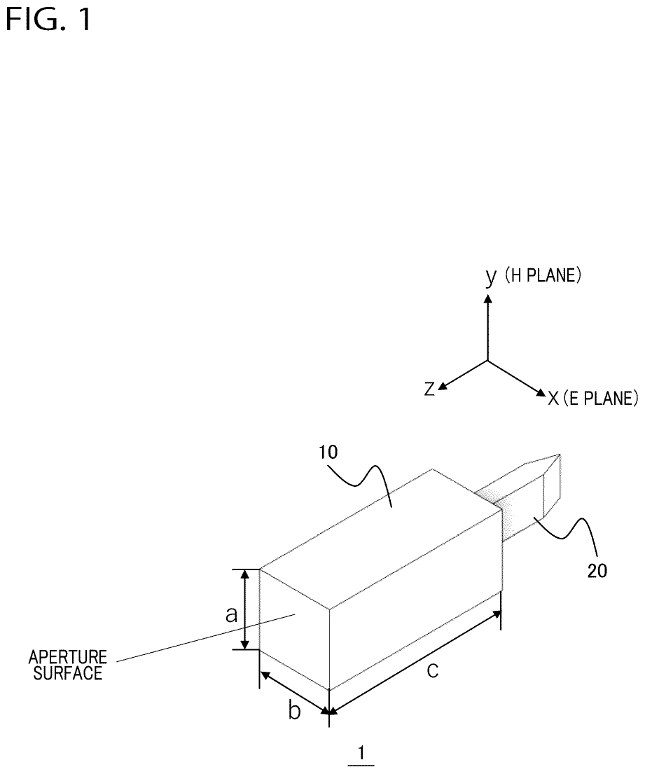

FIG. 1 is a perspective diagram of the electromagnetic wave input/output element 1 according to the first embodiment. The electromagnetic wave input/output element 1 can be mounted by inserting it into a waveguide commonly used in the millimeter wave and terahertz wave bands. The electromagnetic wave input/output element 1 comprises a dielectric cube 10 and a tapered protrusion 20.

The dielectric cube 10 is composed of a dielectric three dimensional object that forms a rectangular shape. The surface of the dielectric cube 10 that inputs and outputs electromagnetic waves (the left end face in FIG. 1) is hereinafter referred to as the aperture surface. The aperture surface forms a rectangle with the length of the short side a and the length of the long side b. The length of the dielectric cube 10 in the direction perpendicular to the aperture surface is c. Then, in this example, a=1.62λ, b=1.62λ, and c=4.00λ, specially in this example, the length of the short side a=length of the long side b. Here, λ is the wavelength of the electromagnetic wave used, typically, millimeter wave or terahertz wave. In this case, the ratio b/c of the length of the long side b to the length c is 0.405. Note that b/c is less than 0.75. Hereafter, the x-axes, y-axes and z-axes in the spatial coordinate system are defined as shown in FIG. 1. That is, the x-z plane forms the E plane and the x-y plane forms the H plane.

In this example, the dielectric cube 10 is formed of polytetrafluoroethylene, hereinafter also referred to as “PTFE”, with a dielectric constant of 2.0 at 300 GHz and a dielectric loss tangent of 11×10⁻⁴. PTFE has excellent properties of low dielectric loss at high frequencies.

The protrusion 20 is provided on a surface opposite the aperture surface of the dielectric cube 10. By inserting the protrusion 20 into the waveguide, the electromagnetic wave input/output element 1 can be easily attached to the waveguide. The protrusion 20 has a tapered tip. By making the tip tapered, the effect of reflection can be reduced. The protrusion 20 may be formed of the same material as the dielectric cube 10 or of a different material.

The electromagnetic wave input/output element 1 does not necessarily have to have the protrusion 20. In this case, the dielectric cube 10 itself constitutes the electromagnetic wave input/output element 1.

Each of the hexahedral faces comprising the dielectric cube 10 may be a parallelogram which is not a rectangle. In other words, the dielectric cube 10 may comprise a dielectric three dimensional object that forms the shape of a parallelepiped.

The three dimensional object comprising the dielectric cube 10 may have all or some of its edges truncated. In other words, the three dimensional object comprising the dielectric cube 10 may be truncated with respect to all or some of the edges (ridge) by a plane, e.g., flat or curved, substantially parallel to said edges (ridge). In other words, the dielectric cube 10 may comprise a dielectric three dimensional object that forms a shape in which at least one edge of the parallelepiped is truncated.

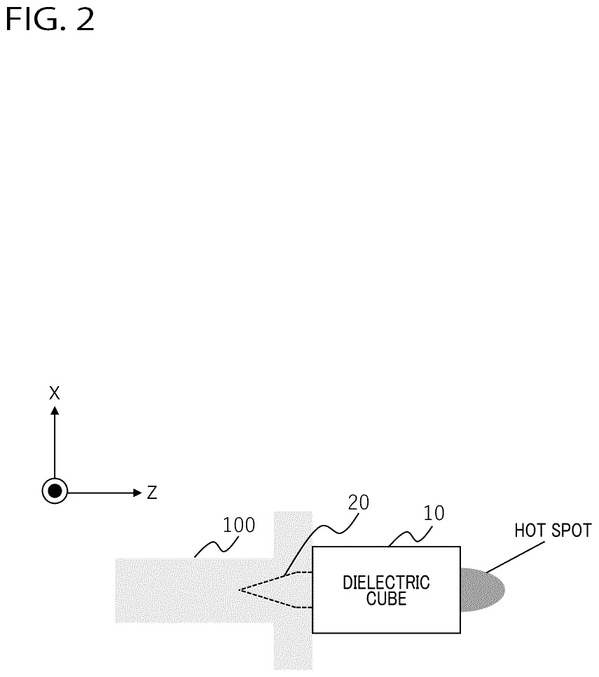

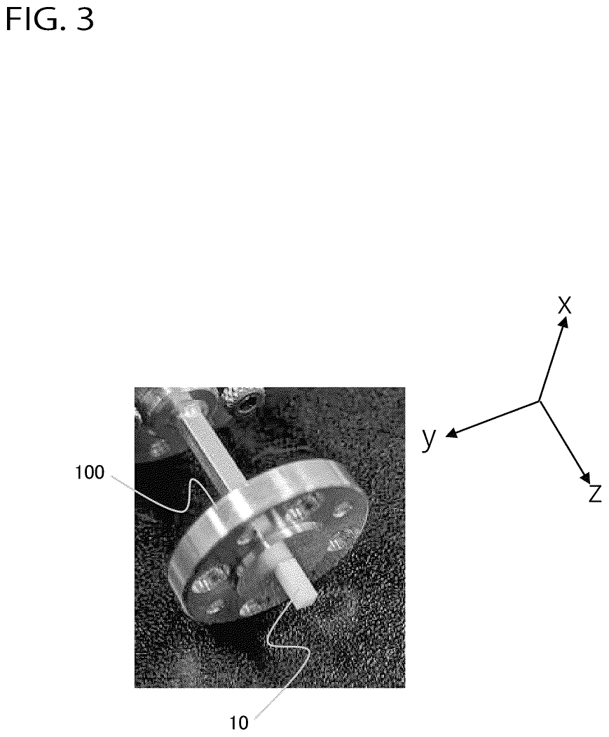

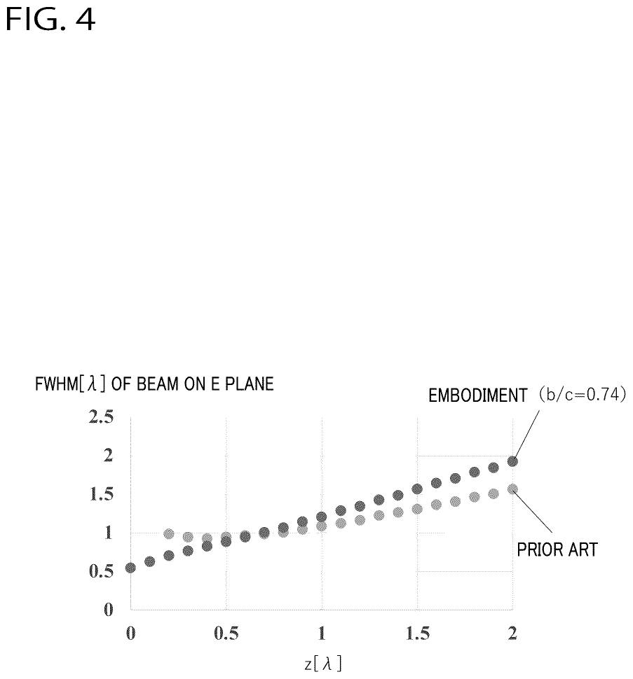

FIG. 2 schematically shows an electromagnetic input/output element 1 inserted in a waveguide 100. FIG. 3 is a photograph of the electromagnetic wave input/output element 1 inserted into the waveguide 100. Due to the effect of the photonic jet, a hot spot of high intensity electromagnetic field is formed from the aperture surface of the dielectric cube 10. By irradiating this hot spot as an electromagnetic wave beam onto an irradiated target and measuring its reflected wave, the irradiated target can be imaged. The electromagnetic wave beams generated in the three cases of ratio b/c=0.74, 0.59 and 0.41 are described below. The results shown in FIGS. 4 through 29 below are based on simulations.

### In the Case of b/c=0.74

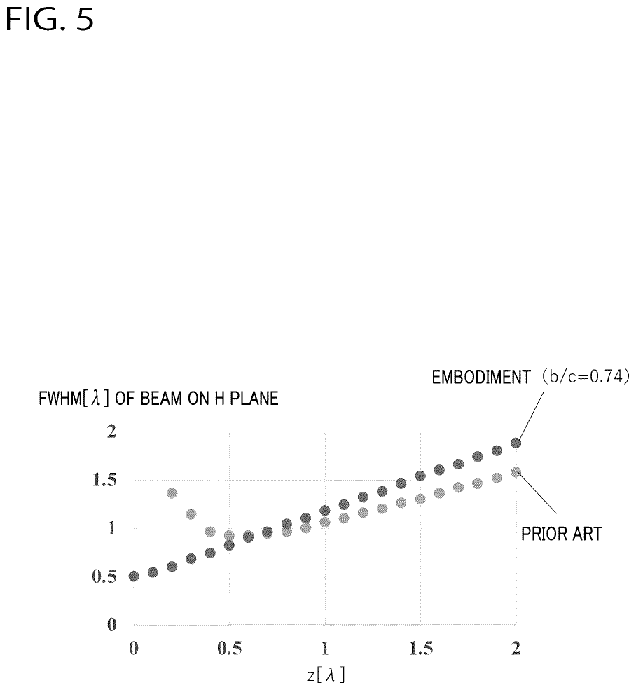

FIG. 4 shows the z-direction dependence, i.e., propagation distance dependence, of the full width at half maximum in the E plane, hereinafter also referred to as “FWHM”, of the electromagnetic wave beam generated by the electromagnetic wave input/output element with b/c=0.74 according to the embodiment. The FWHM of the electromagnetic wave beam corresponds to the resolution in imaging applications. FIG. 4 also shows the FWHM of the electromagnetic wave beam generated by the prior art, i.e., the antenna described in Non Patent Literature 1, the same applies below. In the following characteristic diagram of this type, both the vertical and horizontal axes are shown as values normalized by the wavelength λ. FIG. 5 shows the z-direction dependence of the FWHM in the H plane of the electromagnetic wave beam in FIG. 4.

In both the E plane and the H plane, the FWHM of the embodiment is narrower than that of the prior art in the region nearer from z=0.7λ. On the other hand, in the region farther from z=0.7λ, the FWHM of the prior art is narrower than that of the embodiment. The FWHM of the embodiment increases monotonically with the propagation distance, i.e., distance in the z direction. On the other hand, the FWHM of the prior art takes a minimum value around z=0.4λ to 0.5λ and starts increasing from decreasing. In particular, the FWHM of the prior art beam in the H plane significantly widens in the region near z=0.4λ, resulting in a decrease in resolution. Most notably, the prior art beam splits in the region near z=0.2λ and the FWHM cannot be defined. Therefore, both FIGS. 4 and 5 do not plot the prior art beam at z=0 and 0.1λ. In this case, the prior art cannot be used with the antenna closer than 0.2λ to the irradiated target. In contrast, the beam according to the embodiment does not split even at z=0. In other words, the imaging element can be used in close proximity to the irradiation target because the beam does not split in the aperture plane in the embodiment.

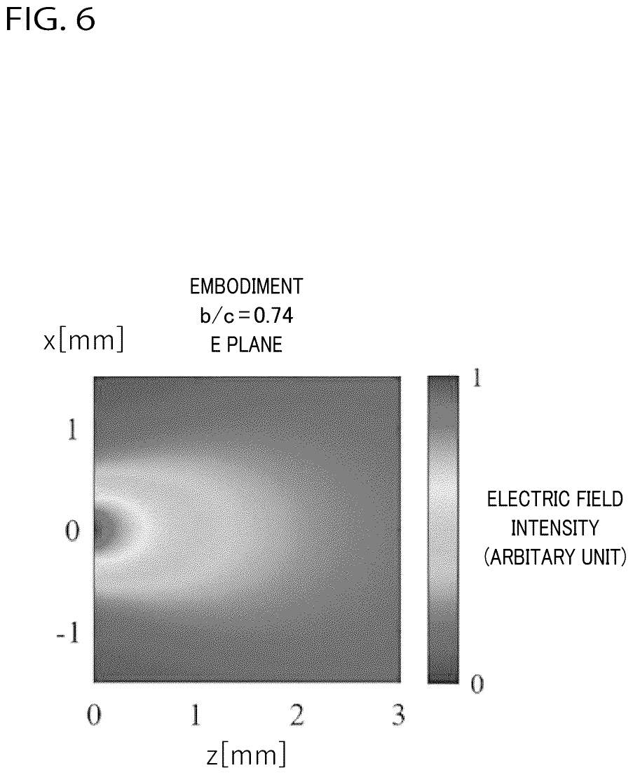

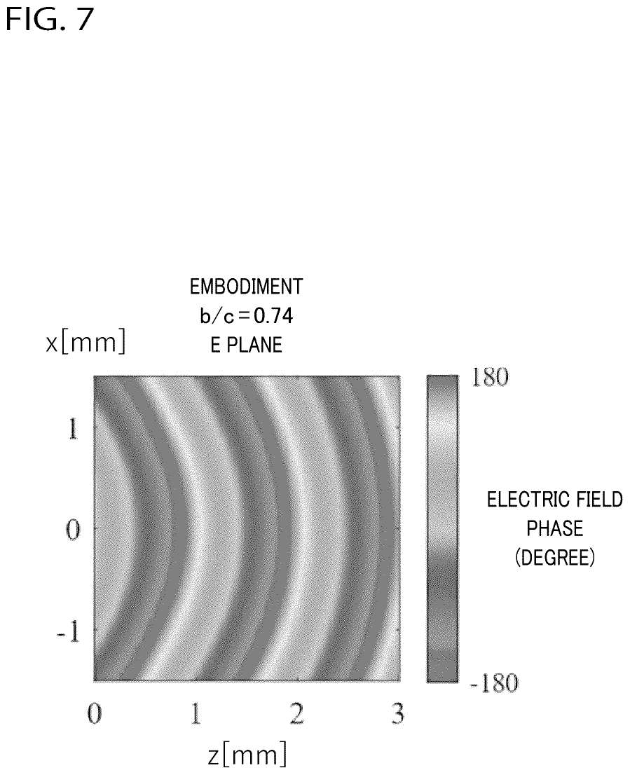

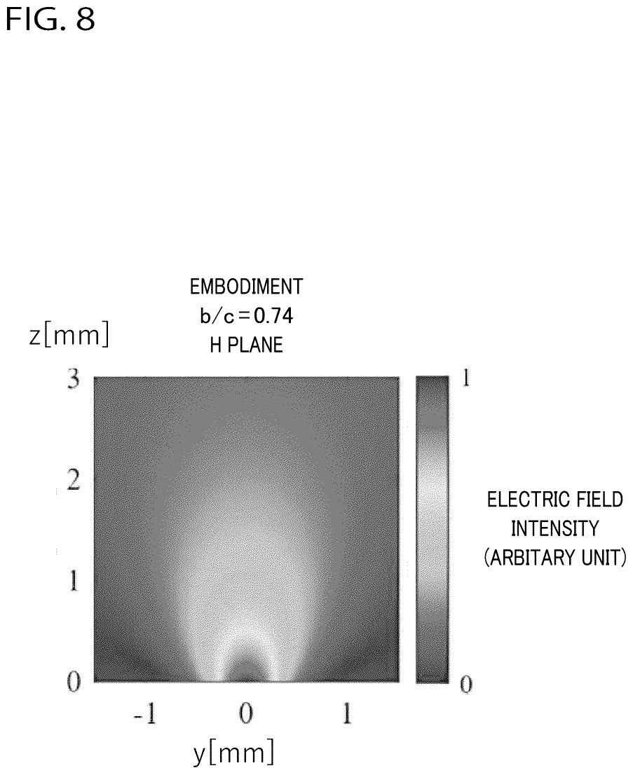

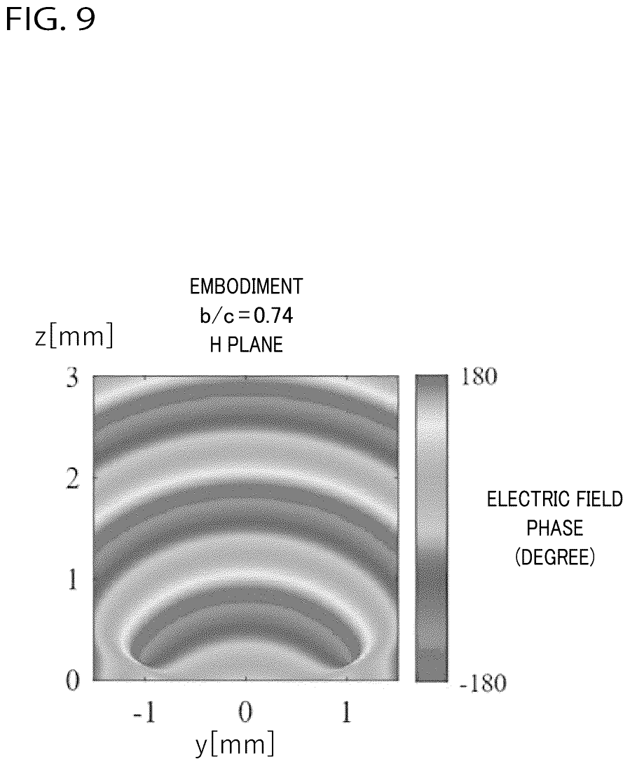

FIG. 6 shows the intensity distribution of the electric field in the E plane of an electromagnetic wave beam according to the embodiment. FIG. 7 shows the phase distribution of the electric field in the E plane of an electromagnetic wave beam according to the embodiment. FIG. 8 shows the intensity distribution of the electric field in the H plane of an electromagnetic wave beam according to the embodiment. FIG. 9 shows the phase distribution of the electric field in the H plane of an electromagnetic wave beam according to the embodiment. In FIGS. 6 and 8, it can be seen that the electric field intensity is strong in the area tangential to the aperture plane, and the electric field intensity becomes weaker as the area moves away from the center of the aperture plane in the vertical direction.

As explained above, according to the embodiment, the imaging element can be used in close contact with the irradiation target, although the resolution at a distance farther than z=0.7λ is worse.

### In the Case of b/c=0.59

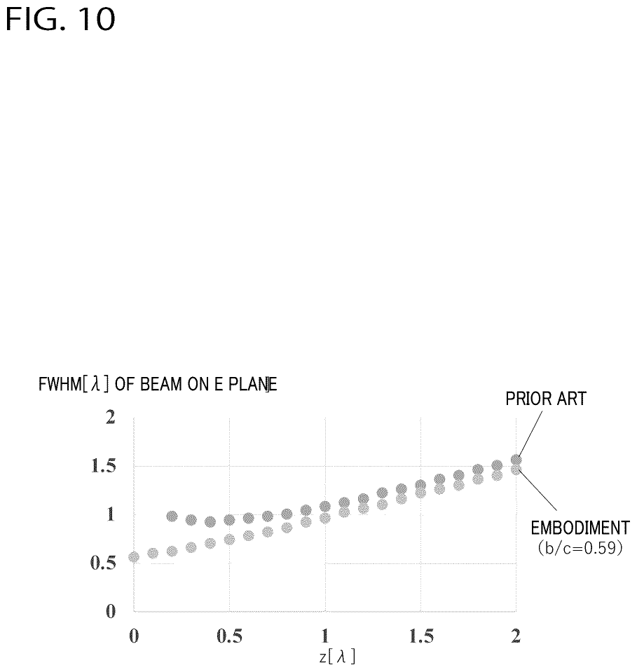

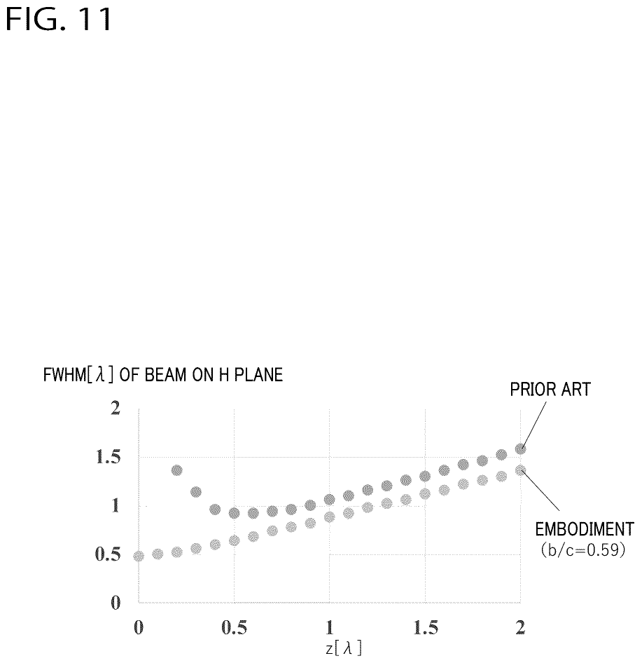

FIG. 10 shows the z-direction dependence of the FWHM in the E plane of an electromagnetic wave beam generated by an electromagnetic wave input/output element with b/c=0.59 according to the embodiment. FIG. 10 also shows the FWHM of the electromagnetic wave beam generated by the prior art. FIG. 11 shows the z-direction dependence of the FWHM in the H plane of the electromagnetic wave beam in FIG. 10.

For b/c=0.59, the FWHM of the embodiment is narrower than that of the prior art over the entire region up to z=2λ, unlike the case of b/c=0.74. In other words, by taking b/c=0.59, an imaging element with higher resolution than the prior art can be obtained at least in the region from the surface to about 2 wavelengths.

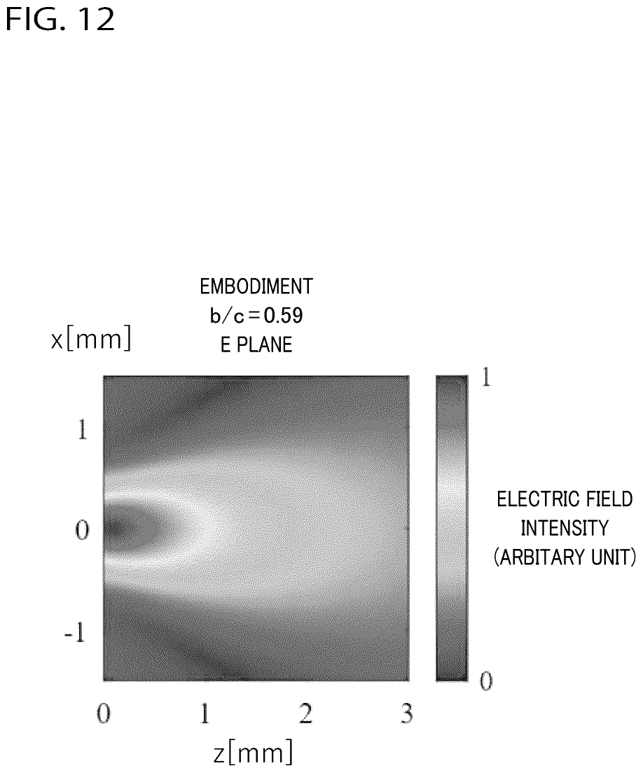

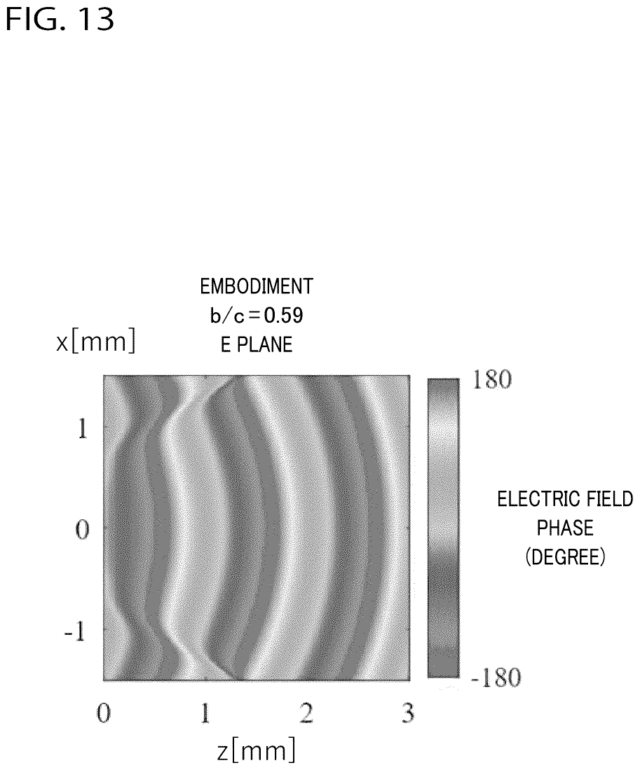

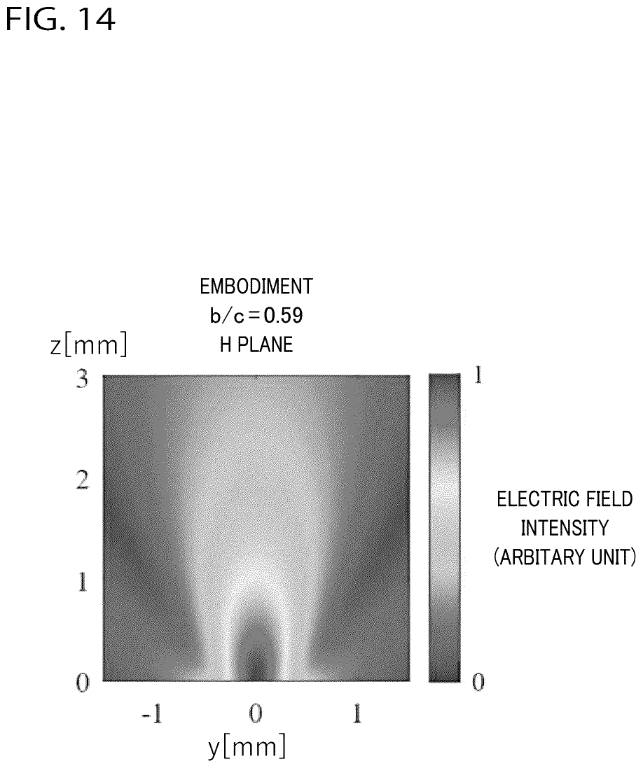

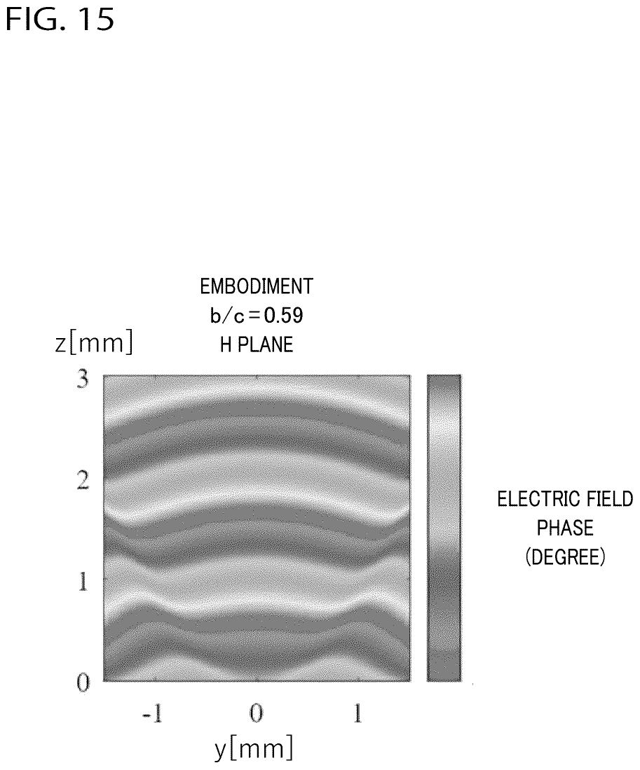

FIG. 12 shows the intensity distribution of the electric field in the E plane of an electromagnetic wave beam according to the embodiment. FIG. 13 shows the phase distribution of the electric field in the E plane of an electromagnetic wave beam according to the embodiment. FIG. 14 shows the intensity distribution of the electric field in the H plane of an electromagnetic wave beam according to the embodiment. FIG. 15 shows the phase distribution of the electric field in the H plane of an electromagnetic wave beam according to the embodiment. In FIGS. 12 and 14, as in FIGS. 6 and 8, it can be seen that the electric field intensity is strong in the area tangential to the aperture plane, and the electric field intensity becomes weaker as the area moves away from the center of the aperture plane in the vertical direction, and the hot spot is wider in the direction perpendicular to the aperture plane than in FIGS. 6 and 8.

### In the Case of b/c=0.41

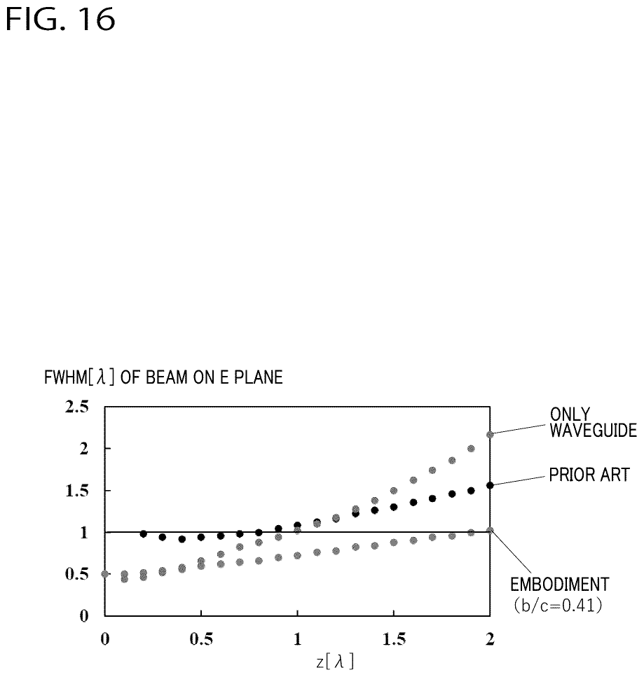

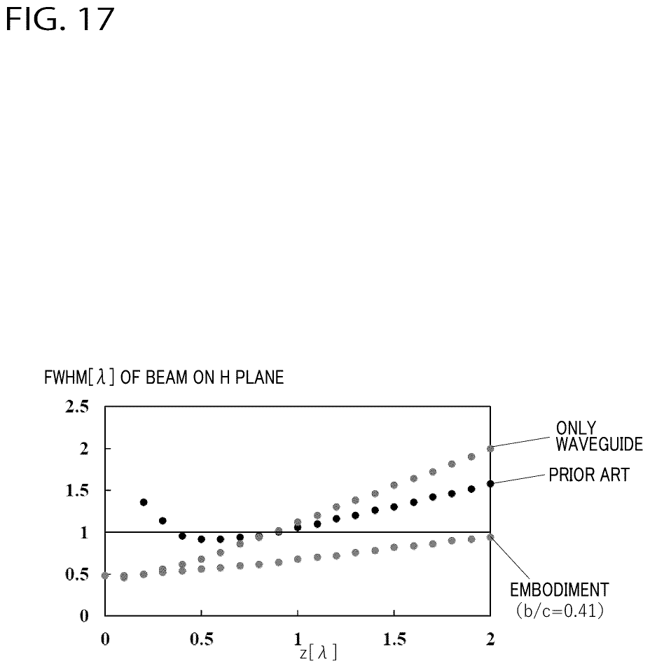

FIG. 16 shows the z-direction dependence of the FWHM in the E plane of an electromagnetic wave beam generated by an electromagnetic wave input/output element with b/c=0.41 according to the embodiment. FIG. 16 also shows the FWHM of the electromagnetic wave beam generated by the prior art and the FWHM of the electromagnetic wave beam generated when only the waveguide (WR3.4) is present. FIG. 17 shows the z-direction dependence of the FWHM in the H plane of the electromagnetic wave beam in FIG. 16.

Even when only a waveguide is present, the beam splits at z=0, so this point is not plotted in FIGS. 16 and 17.

The embodiment has even better characteristics at b/c=0.41 than at b/c=0.74. That is, over the entire region up to z=2λ, the FWHM of the embodiment is less than one wavelength. Therefore, by taking b/c=0.41, it is possible to provide an electromagnetic wave input/output element that can input/output electromagnetic wave beams with a beam width that does not exceed one wavelength, i.e., achieving sub-wavelength resolution, at least in the region from the surface to about two wavelengths.

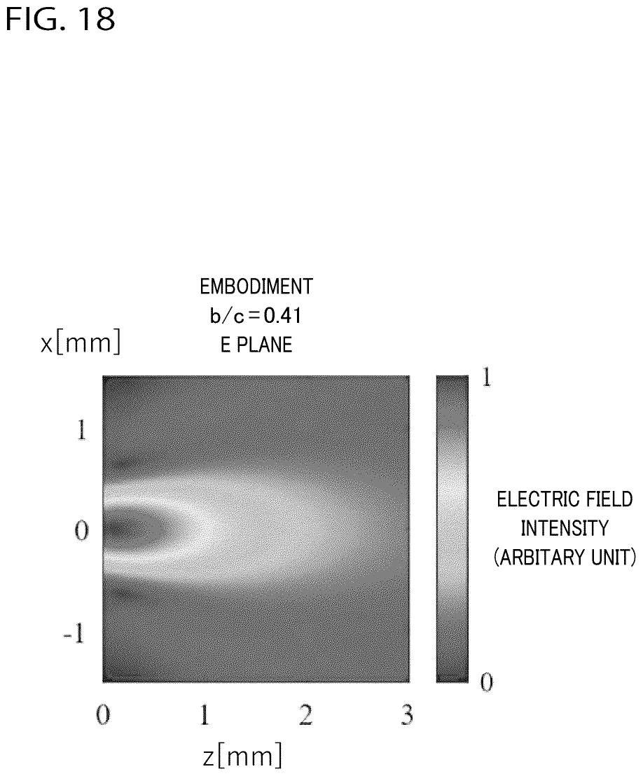

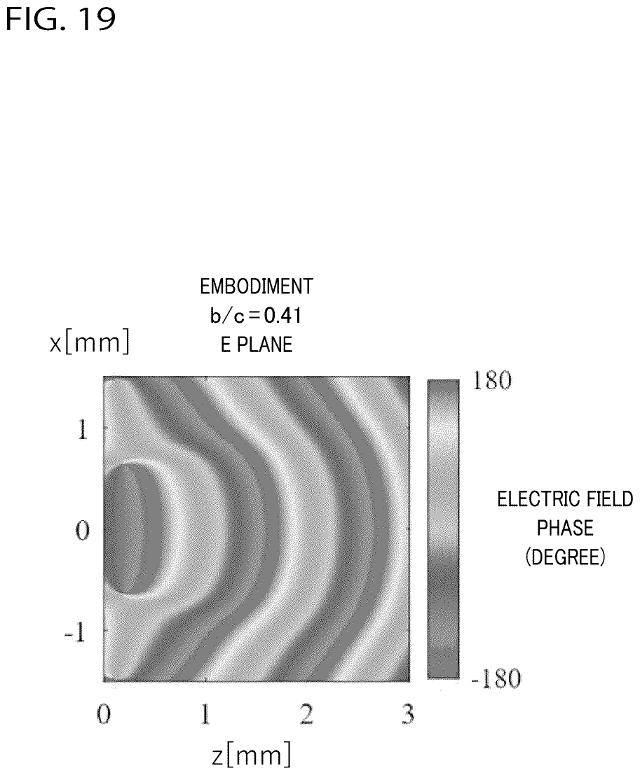

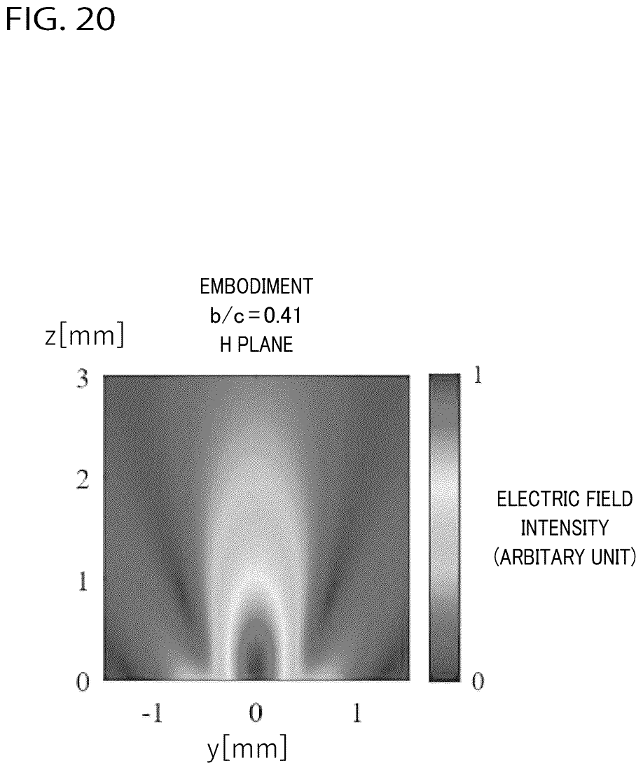

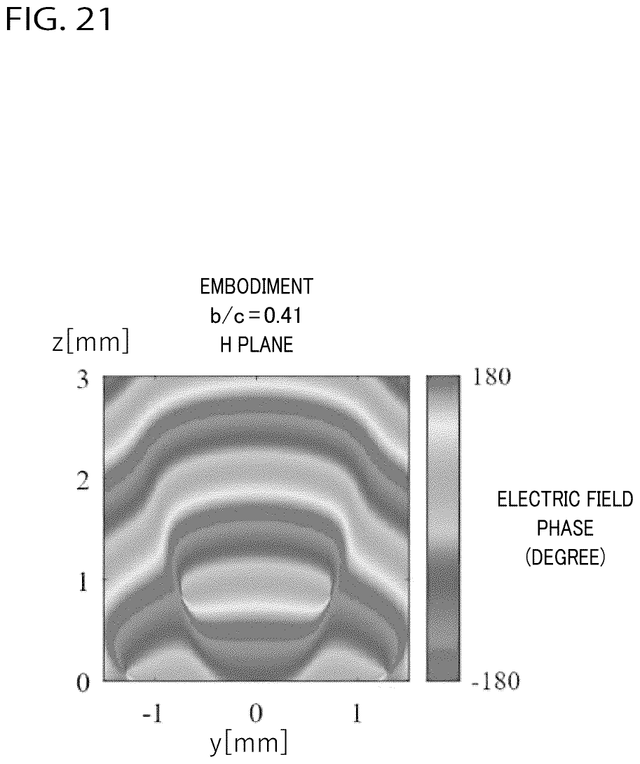

FIG. 18 shows the intensity distribution of the electric field in the E plane of an electromagnetic wave beam according to the embodiment. FIG. 19 shows the phase distribution of the electric field in the E plane of an electromagnetic wave beam according to the embodiment. FIG. 20 shows the intensity distribution of the electric field in the H plane of an electromagnetic wave beam according to the embodiment. FIG. 21 shows the phase distribution of the according to the embodiment. In FIGS. 18 and 20, as in FIGS. 6 and 8, it can be seen that the electric field intensity is strong in the area tangential to the aperture plane, and the electric field intensity becomes weaker as the area moves away from the center of the aperture plane in the vertical direction, and the hot spot is wider in the direction perpendicular to the aperture plane than in FIGS. 12 and 14.

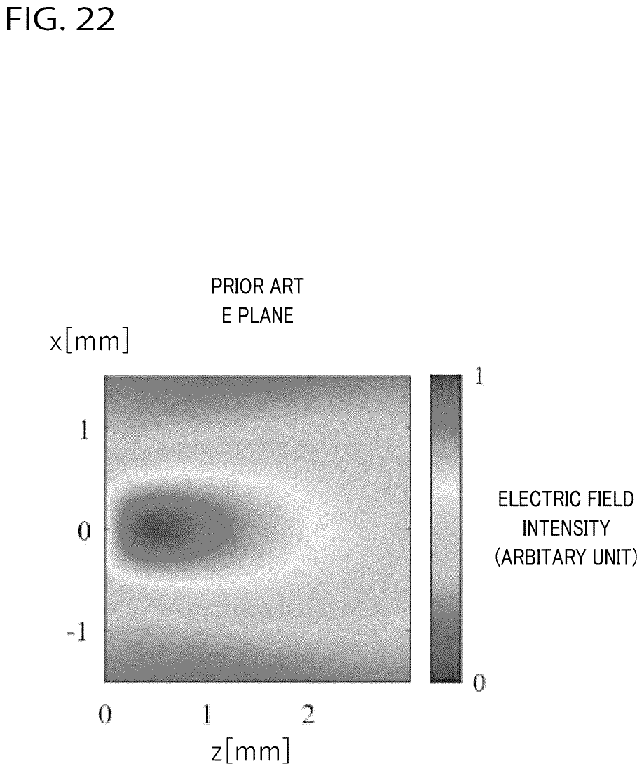

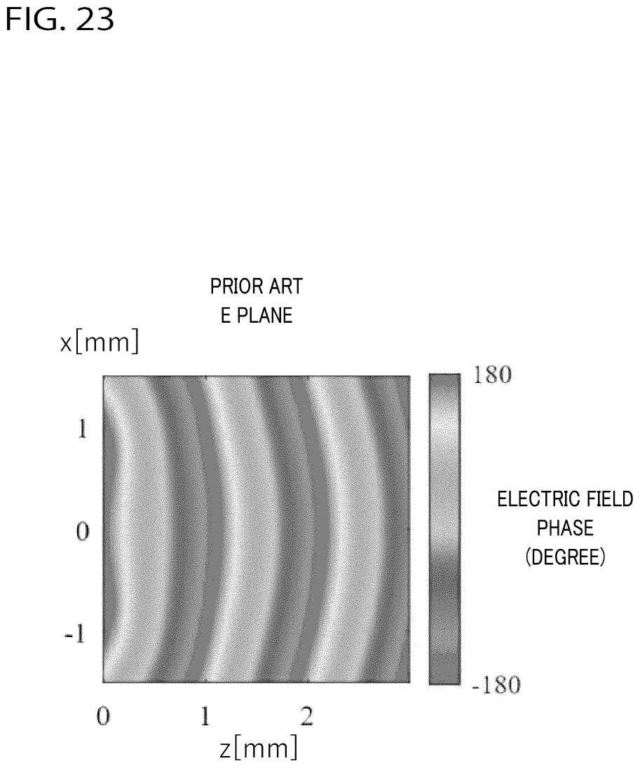

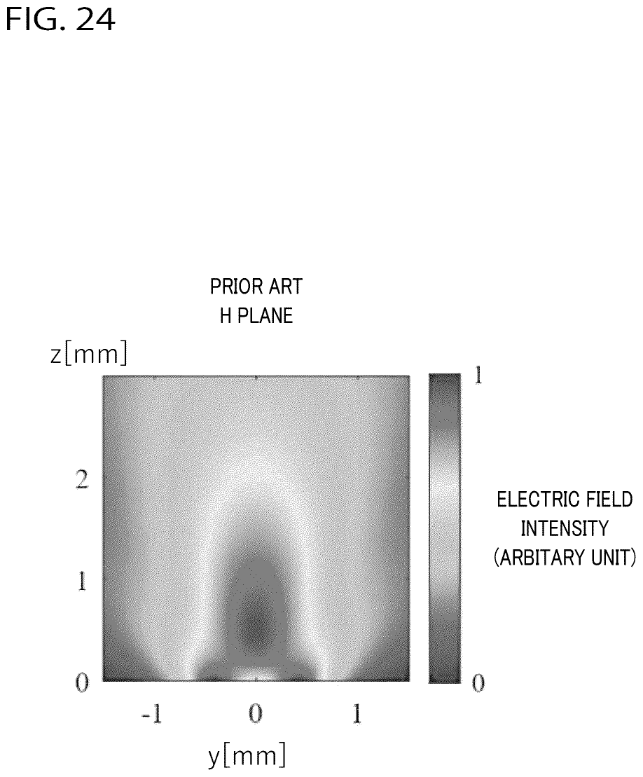

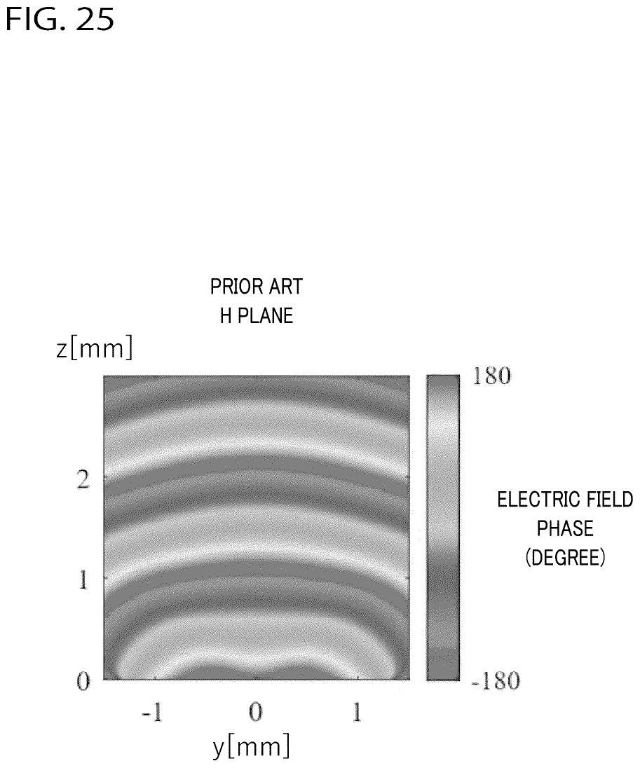

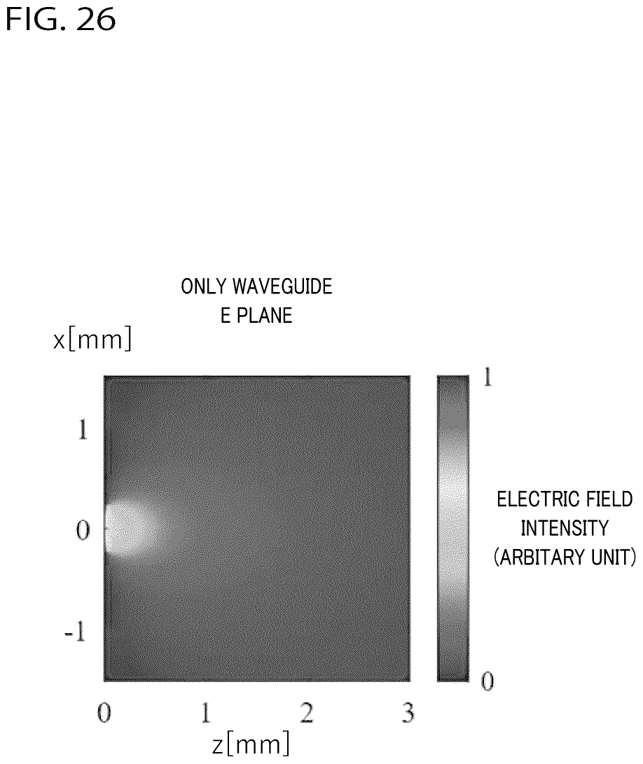

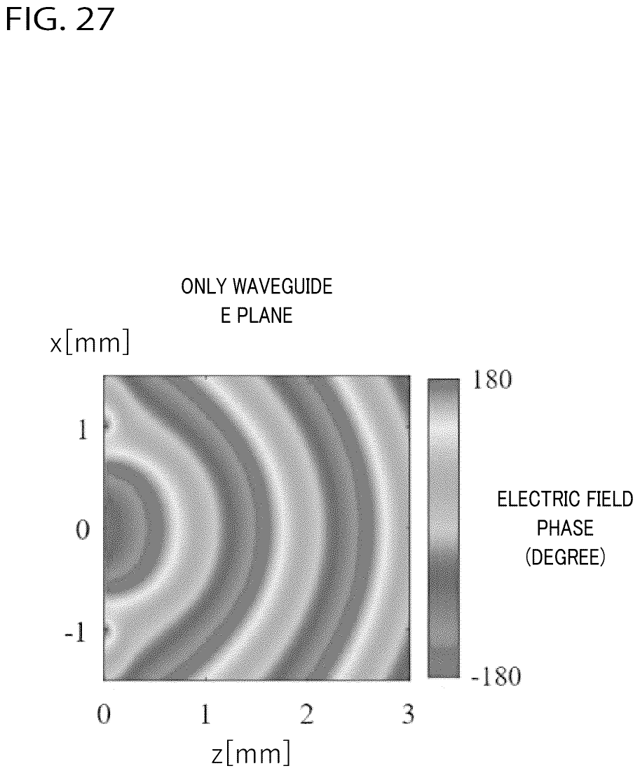

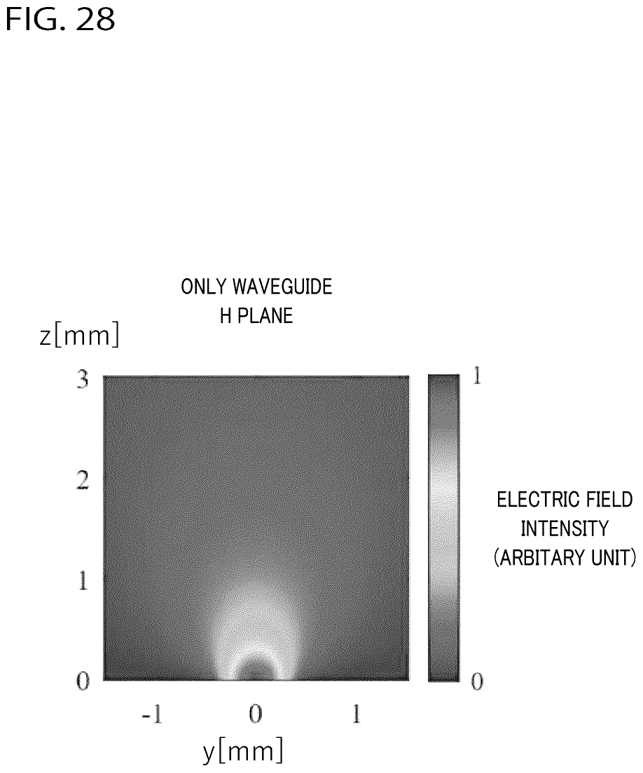

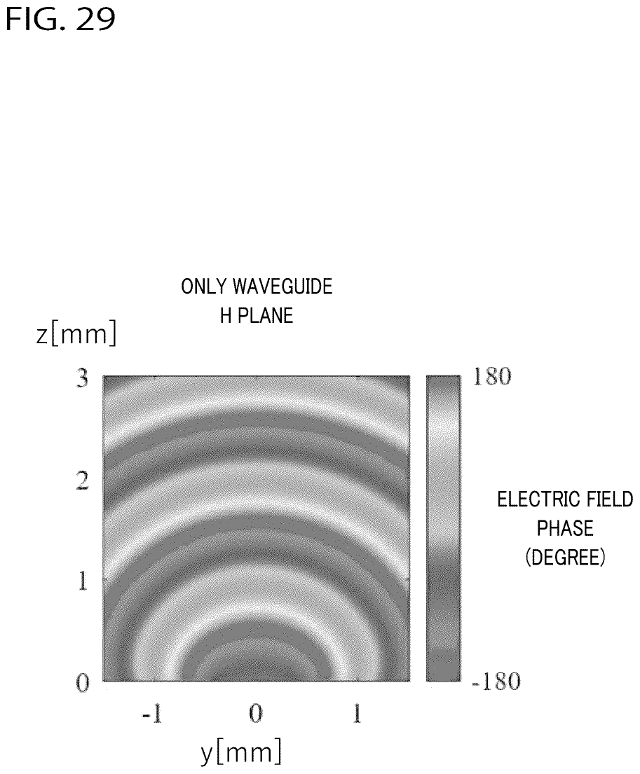

FIG. 22 shows the intensity distribution of the electric field in the E plane of an electromagnetic wave beam in the prior art. FIG. 23 shows the phase distribution of the electric field in the E plane of an electromagnetic wave beam in the prior art. FIG. 24 shows the intensity distribution of the electric field in the H plane of an electromagnetic wave beam in the prior art. FIG. 25 shows the phase distribution of the electric field in the H plane of an electromagnetic wave beam in the prior art. FIG. 26 shows the intensity distribution of the electric field in the E plane of an electromagnetic wave beam of the waveguide only. FIG. 27 shows the phase distribution of the electric field in the E plane of an electromagnetic wave beam of the waveguide only. FIG. 28 shows the intensity distribution of the electric field in the H plane of an electromagnetic wave beam of the waveguide only. FIG. 29 shows the phase distribution of the electric field in the H plane of an electromagnetic wave beam of the waveguide only.

The following is a summary of the effects of this form of electromagnetic wave input/output element.

The electromagnetic wave input/output element of this embodiment has a flat surface in contact with the irradiation target, i.e., the aperture surface of the dielectric cube. This gives it the advantage of being less likely to break even if it comes into contact with the irradiation target, compared to conventional needle-shaped probes.

The electromagnetic wave input/output element of this embodiment has an extremely simple configuration as explained above. In particular, the entire device can be made very compact since an imaging system combining lenses and mirrors is not necessary.

The electromagnetic wave input/output element of this embodiment can be used for imaging simply by inserting it into a waveguide. Therefore, adjustment of the optical system is extremely simple and easy to use.

According to the electromagnetic wave input/output element of this embodiment, the beam does not split at the aperture surface when b/c=0.74. This makes it possible to obtain an imaging element that can be used in close contact with the irradiation target.

Furthermore, by setting b/c≤0.59, an imaging element with higher resolution than the prior art can be obtained in the region from the surface to at least two wavelengths.

Furthermore, by setting b/c≤0.41, it is possible to provide an electromagnetic wave input/output element that can input/output an electromagnetic wave beam with a beam width not exceeding one wavelength, i.e., realizing sub-wavelength resolution, in the region from the surface to at least two wavelengths.

### The Second Embodiment

### Example 1

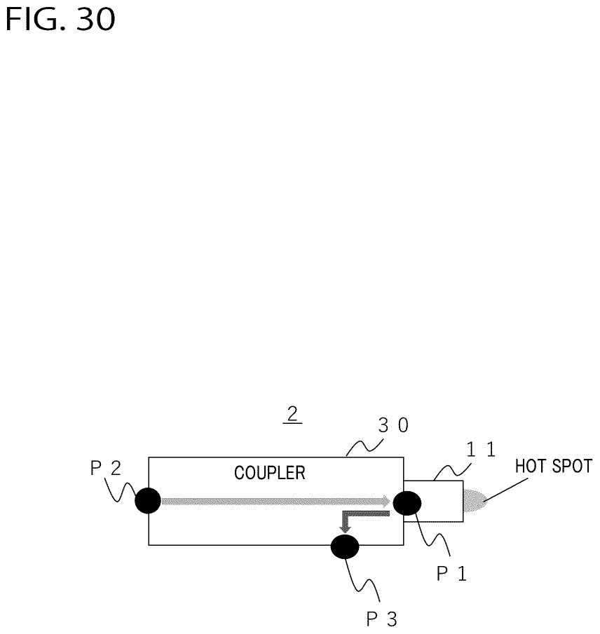

FIG. 30 shows a functional block diagram of the electromagnetic wave input/output head 2, which is the first example of the second embodiment. The electromagnetic wave input/output head 2 comprises a coupler 30 and an electromagnetic wave input/output element 11. The coupler 30 comprises a first port P1, a second port P2 and a third port P3. The electromagnetic wave input/output element 11 forms a parallelepiped. The electromagnetic wave input/output element 11 is attached to the first port P1 of the coupler 30.

A signal from an external source, such as an electromagnetic wave output source, inputs to the second port P2. The third port P3 outputs the signal from the first port, for example, the electromagnetic wave beam reflected by the irradiation target and input to the electromagnetic wave input/output element 11.

According to this example, an electromagnetic wave input/output head can be realized with an input port from the outside, i.e., second port P2, and an output port to the outside, i.e., third port P3.

### Example 2

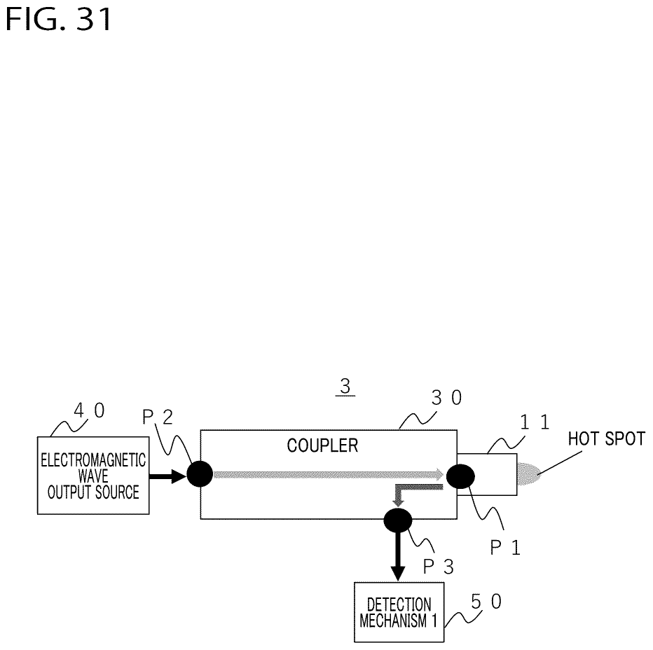

FIG. 31 shows a functional block diagram of the electromagnetic wave input/output head 3, which is the second example of the second embodiment. The electromagnetic wave input/output head 3 comprises a coupler 30 and an electromagnetic wave input/output element 11. The coupler 30 comprises a first port P1, a second port P2 and a third port P3. The electromagnetic wave input/output element 11 forms a parallelepiped. The electromagnetic wave input/output element 11 is attached to the first port P1 of the coupler 30. The second port P2 is connected to the output source 40 of electromagnetic waves. The third port P3 is connected to the first electromagnetic wave detecting unit 50. In other words, this electromagnetic wave input/output head 3 consists of the second port P2 and the third port P3 of the electromagnetic wave input/output head 2 in FIG. 30 connected to the output source 40 of electromagnetic waves and the first electromagnetic wave detecting unit 50, respectively.

According to this example, the electromagnetic waves generated by the output source 40 of electromagnetic waves can be irradiated to the irradiated target using the electromagnetic wave input/output element 11, and after receiving the reflected waves therefrom, signal detection, imaging, etc. can be performed using the first electromagnetic wave detecting unit 50.

### Example 3

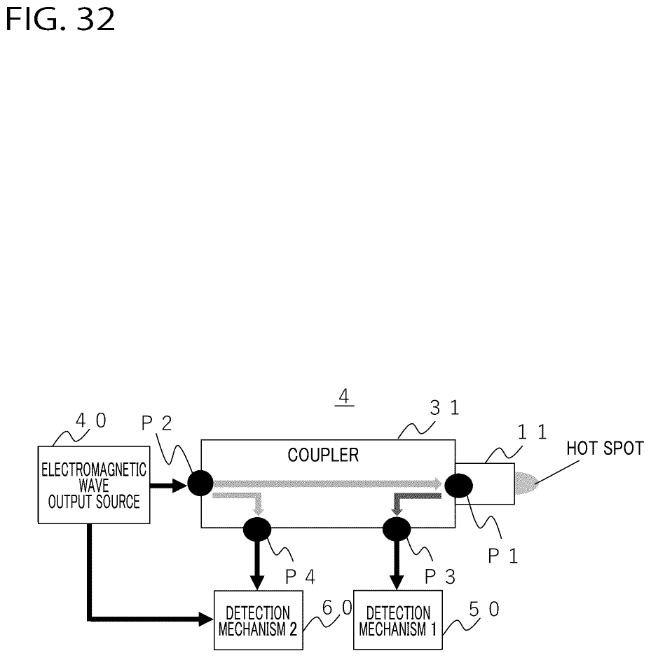

FIG. 32 shows a functional block diagram of the electromagnetic wave input/output head 4, which is the third example of the second embodiment. The electromagnetic wave input/output head 4 comprises a coupler 31 and an electromagnetic wave input/output element 11. The coupler 31 comprises a first port P1, a second port P2, a third port P3 and a fourth port P4. The electromagnetic wave input/output element 11 forms a parallelepiped. The electromagnetic wave input/output element 11 is attached to the first port P1 of the coupler 31. The second port P2 is connected to the output source 40 of electromagnetic waves. The third port P3 is connected to the first electromagnetic wave detecting unit 50. The fourth port P4 is connected to the second electromagnetic wave detecting unit 60. In other words, this electromagnetic wave input/output head 4 is configured with the coupler 31 comprising an additional fourth port P4, compared to the electromagnetic wave input/output head 3 in FIG. 31. The fourth port P4 outputs signals of electromagnetic waves generated by the output source 40 of electromagnetic waves.

According to this example, the reflected wave signal from the irradiated object can be detected using the first electromagnetic wave detecting unit 50, while the electromagnetic wave signal generated at the output source 40 of electromagnetic waves can be detected using the second electromagnetic wave detecting unit 60.

### Example 4

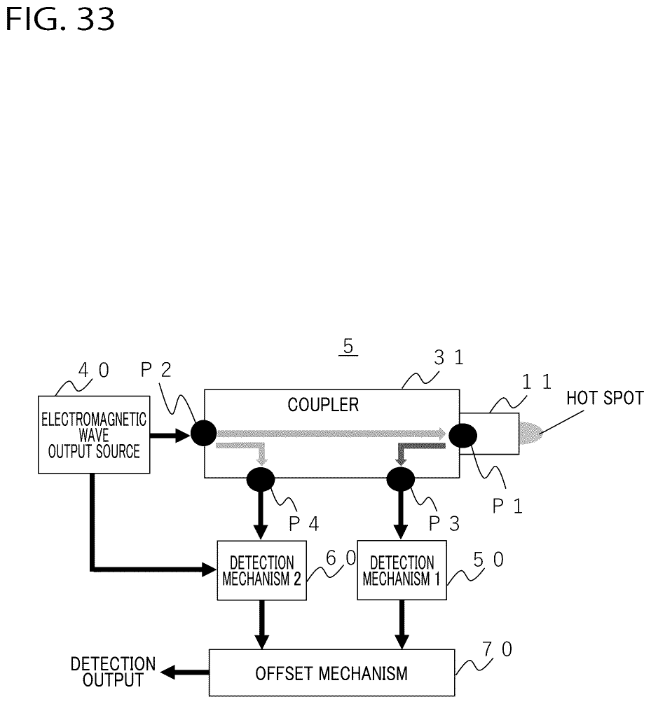

FIG. 33 shows a functional block diagram of the electromagnetic wave input/output head 5, which is the fourth example of the second embodiment. The electromagnetic wave input/output head 5 comprises a coupler 31 and an electromagnetic wave input/output element 11. The coupler 31 comprises a first port P1, a second port P2, a third port P3 and a fourth port P4. The electromagnetic wave input/output element 11 forms a parallelepiped. The electromagnetic wave input/output element 11 is attached to the first port P1 of the coupler 31. The second port P2 is connected to the output source 40 of electromagnetic waves. The third port P3 is connected to the first electromagnetic wave detecting unit 50. The fourth port P4 is connected to the second electromagnetic wave detecting unit 60. The first electromagnetic wave detecting unit 50 and/or the second electromagnetic wave detecting unit 60 is connected to the offset unit 70. The offset unit 70 compares, for example, cancels or superimposes, etc., the signals of the first electromagnetic wave detecting unit 50 and the second electromagnetic wave detecting unit 60 and outputs the result as a detection output. For example, the offset unit 70 can cancel out amplitude fluctuations in the output of the output source 40 of electromagnetic waves by taking the ratio or difference between the detection output of the first electromagnetic wave detecting unit 50 and that of the second electromagnetic wave detecting unit 60. Phase fluctuations in the output of the output source 40 of electromagnetic waves can be eliminated by superimposing the output of a separately installed electromagnetic wave output source on the output of the first electromagnetic wave detecting unit 50 and on the output of the second electromagnetic wave detecting unit 60.

According to this example, a more accurate detection result can be obtained because the reflected wave signal from the irradiated object and the electromagnetic wave signal generated by the output of the output source of electromagnetic waves can be compared and processed.

### Verification Experiment 1

The inventors conducted experiments to verify the effects of the electromagnetic wave input/output element of the embodiment. The specific experiment was a nondestructive inspection in which an electromagnetic wave beam was irradiated from the electromagnetic wave input/output element of the embodiment to a generally circulating transportation system IC card, and the card was imaged.

The electromagnetic wave input/output element of the embodiment shown in FIG. 1 has a=1.62λ, b=1.62λ and c=4.00λ. Here, the wavelength of the electromagnetic wave λ is 1.00 mm. Therefore, the ratio b/c=0.405. As a control experiment, imaging with electromagnetic waves using the antenna described in Non Patent Literature 1 was performed.

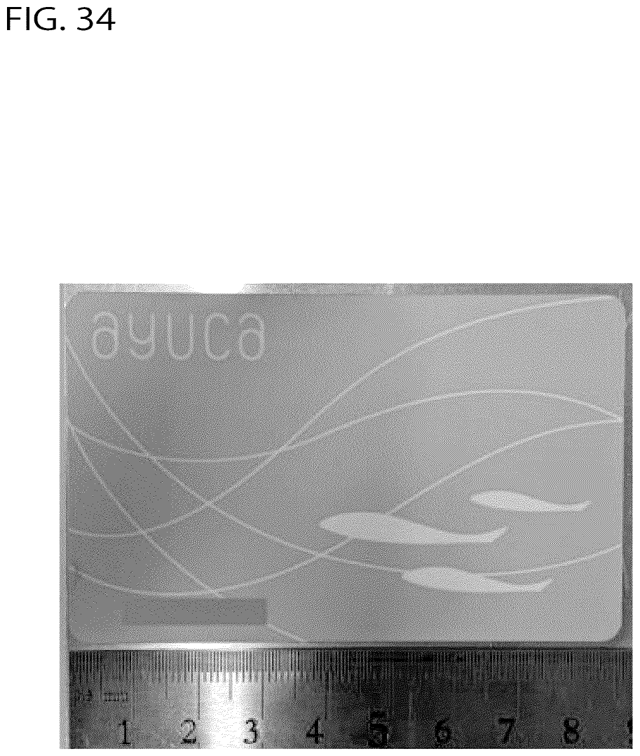

FIG. 34 shows a photograph of the IC card used in the verification experiment. The thickness of the plastic resin on the surface of the IC card is 0.80 mm. An IC circuit containing metal is placed on the back of the IC card. The measurement range on the horizontal plane is 70 mm×40 mm. The amplitude and phase were acquired at intervals of 0.25 mm by sweeping the irradiation target using a precision XY stage for imaging. The distance between the IC card surface and the electromagnetic wave input/output elements and antenna surface is 0.50 mm (λ/2). In other words, the distance from the back of the IC card to the electromagnetic wave input/output element is 1.30 mm (0.50 mm (air)+0.80 mm (thickness of plastic resin)), which is 1.30λ.

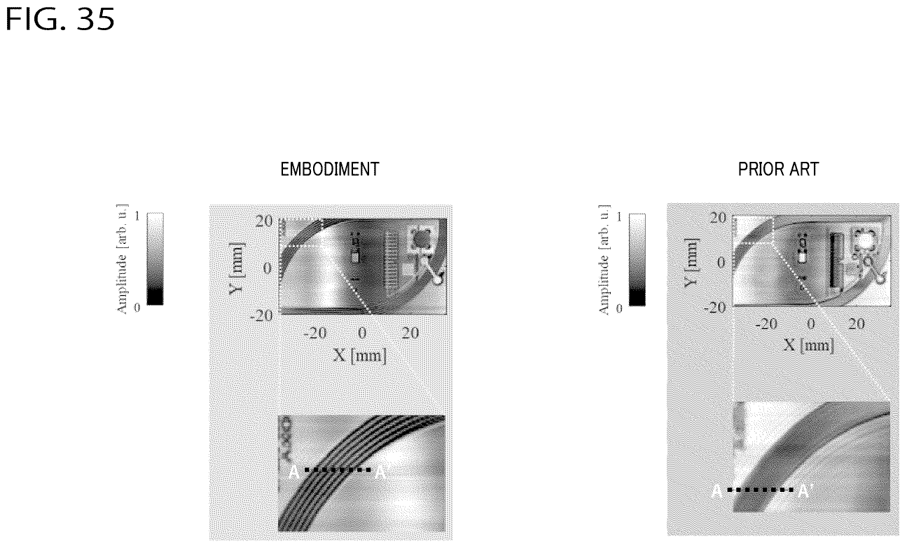

FIG. 35 shows comparison of a photograph of imaging using the electromagnetic wave input/output element according to the embodiment and a photograph of imaging using an antenna of the prior art. Specifically, the upper photograph shows amplitude imaging and the lower photograph shows an enlarged view of the upper left portion of the upper photograph, i.e., the loop antenna portion inside the IC card. As mentioned above, the IC card surface and the electromagnetic wave input/output element are 1.30λ apart. It can be seen that high resolution is achieved by imaging using the electromagnetic wave input/output element of the embodiment. In particular, as shown in the enlarged lower photograph, the loop antenna portion has six dark lines clearly resolved in imaging using the electromagnetic wave input/output element of the embodiment, whereas it is not resolved at all in imaging using the prior art antenna.

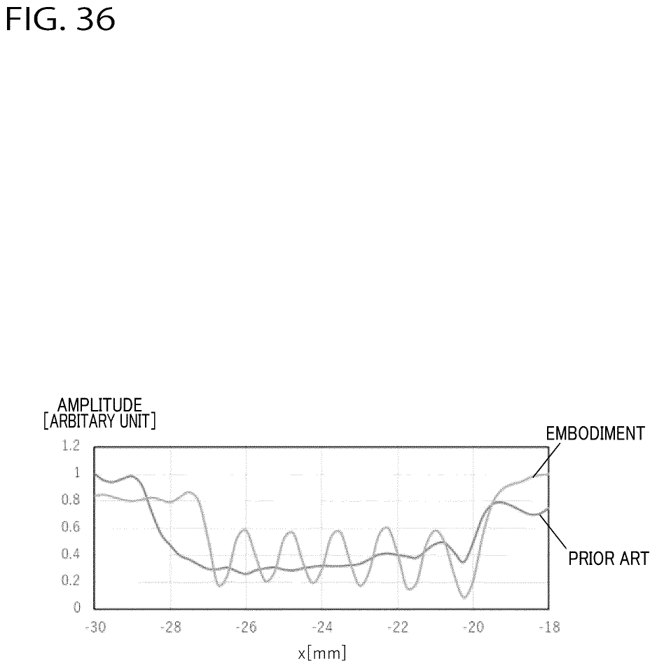

FIG. 36 shows the amplitude data in the A-A′ cross section in the lower part of FIG. 35, loop antenna portion. The loop antenna portion is not resolved in the prior art. On the other hand, it can be seen that according to the embodiment, it is clearly resolved as dark lines with an interval of about 1.25 mm.

### Verification Experiment 2

Depth information can be obtained by converting the phase distribution to optical path difference distribution. If the depth range is less than a wavelength, the conversion from phase information to optical path information, i.e., depth information, can be easily executed because phase wrapping does not occur. As mentioned above, according to the electromagnetic wave input/output element of the embodiment, the lateral resolution can be sub-wavelength in the depth range from the surface to about two wavelengths. Therefore, it is expected that 3D imaging with sub-wavelength resolution can be performed by phase imaging in the range from the surface of the electromagnetic wave input/output element to one wavelength, i.e., 1 mm@300 GHz. The inventors performed the following experiments to verify this.

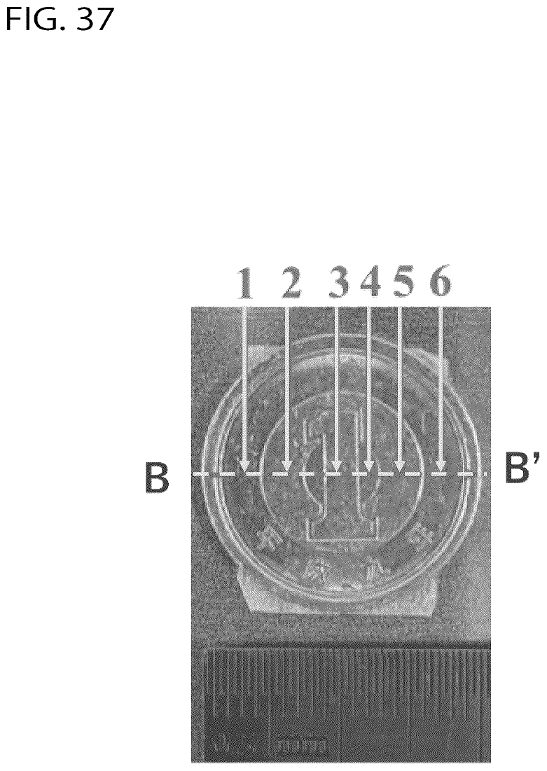

The electromagnetic wave input/output elements used in the experiment are the same as in the verification experiment 1 above. FIG. 37 shows a photograph of a Japanese 1 yen coin used as the irradiation target in this verification experiment. 1 yen coins are made of aluminum and have a maximum surface irregularity of about 0.2 mm, i.e., 0.2λ. When a 1 yen coin is placed with the top and bottom sides correct, the given points on the horizontal diameter are marked with a sign from 1 to 6. Here, points 1, 4 and 6 are on the concave side, while points 2, 3 and 5 are on the convex side.

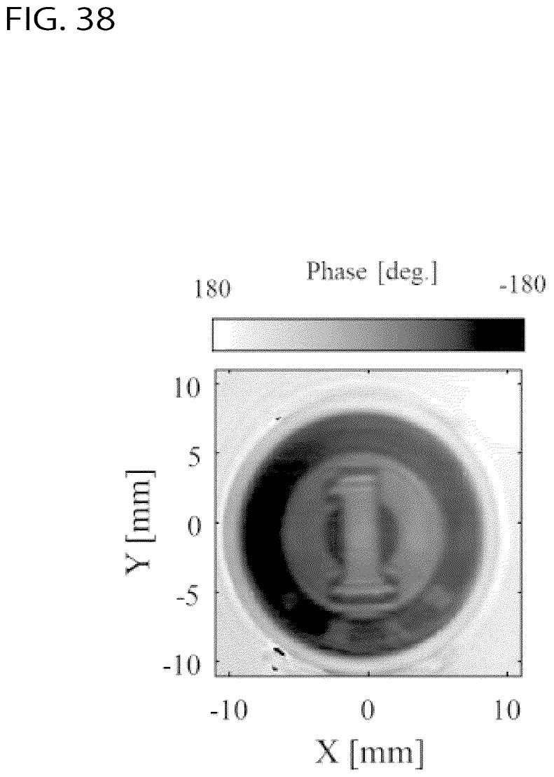

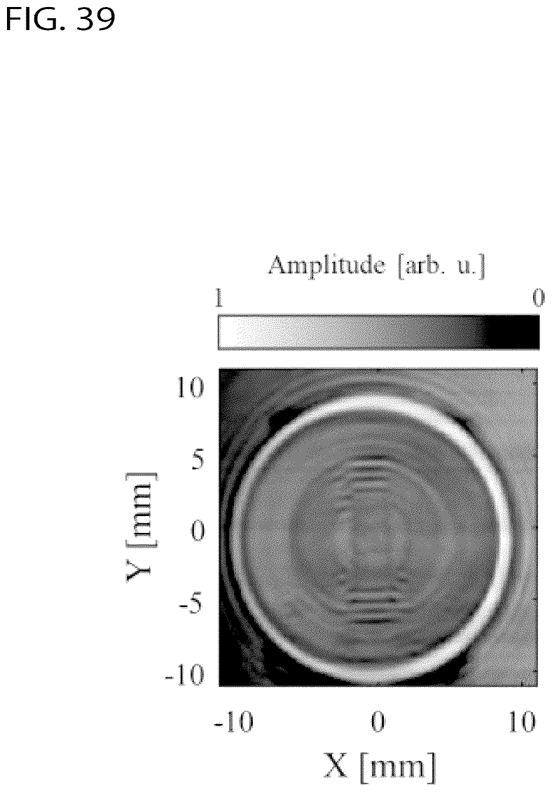

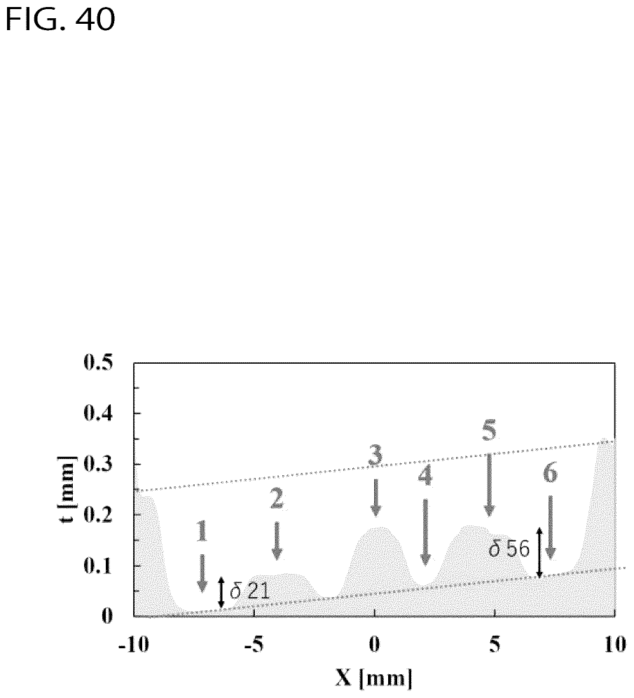

FIG. 38 shows a photograph of phase imaging using the electromagnetic wave input/output device according to the embodiment. FIG. 39 shows a photograph of amplitude imaging using the electromagnetic wave input/output device according to the embodiment. FIG. 40 shows the depth data in the direction of depth in the cross-section B-B′ of FIG. 37, calculated from phase data. It can be seen that the depth of a 1 yen coin can be resolved with high resolution in both the horizontal and depth directions, although the depth data is ridden with a tilt, indicated by the dotted line, due to the fact that the 1 yen coin is tilted. The δ21 calculated from sub-wavelength resolved phase imaging by the electromagnetic wave input/output element of the embodiment is about 71 μm. In contrast, the measurement obtained by laser microscopy is 80 μm. Similarly, δ56 calculated from sub-wavelength resolved phase imaging is about 84 μm. In contrast, the measurement obtained by laser microscopy is 80 μm. Thus, it is verified that the depth direction is resolved with an error of about 10 μm by the embodiment.

### Various Aspects of the Present Disclosure

The electromagnetic wave input/output element according to a certain embodiment of the present disclosure is an electromagnetic wave input/output element that can be attached to a waveguide and comprises a dielectric three dimensional object in the shape of a parallelepiped. The ratio b/c of the length b of the long side of the aperture surface of the parallelepiped and the length c of the side of the parallelepiped in the direction perpendicular to the aperture surface is smaller than 0.75.

According to this embodiment, it is possible to obtain an imaging element that can be used in close contact with the irradiated object.

In one embodiment, the parallelepiped is rectangular parallelepiped.

According to this embodiment, a higher resolution imaging element can be obtained.

In one embodiment, the ratio b/c is 0.6 or less.

According to this embodiment, it is possible to obtain imaging elements with higher resolution than the prior art in the region from the surface to about two wavelengths.

In one embodiment, the ratio b/c is 0.4 or less.

According to this embodiment, it is possible to provide an electromagnetic wave input/output element capable of inputting and outputting an electromagnetic wave beam with a beam width not exceeding one wavelength, i.e., achieving sub-wavelength resolution, in the region from the surface to about two wavelengths.

In one embodiment, the dielectric three dimensional object contains fluorinated resin in the material.

According to this embodiment, the electromagnetic wave input/output element can be formed with a material that has low dielectric loss at high frequencies.

In one embodiment, the surface opposite the aperture surface has a protrusion with a tapered tip for attachment to a waveguide.

According to this embodiment, the electromagnetic wave input/output element can be easily attached to the waveguide and the effect of reflection can be reduced.

In one embodiment, the electromagnetic wave is microwave, millimeter wave or terahertz wave.

According to this embodiment, objects whose size are from μm to mm can be imaged with high resolution.

The electromagnetic wave input/output element according to a certain embodiment of the present disclosure is an electromagnetic wave input/output element that can be attached to a waveguide and comprises a three dimensional object in the shape of a parallelepiped with at least one of its sides truncated. The ratio b/c of the length b of the long side of the aperture surface of the three dimensional object and the length c of the side of the three dimensional object in the direction perpendicular to the aperture surface is 0.75 or less.

According to this embodiment, the degree of freedom of processing during manufacture can be increased.

The electromagnetic wave input/output head according to a certain embodiment of the present disclosure comprises a coupler having at least three ports and an electromagnetic wave input/output element forming a parallelepiped. The electromagnetic wave input/output element is attached to the first port of the coupler.

According to this embodiment, an electromagnetic wave input/output head with an input port from the outside and an output port to the outside can be realized.

In one embodiment, the second port of the coupler is connected to an output source of electromagnetic waves and the third port is connected to the first electromagnetic wave detecting unit.

According to this embodiment, the electromagnetic waves generated by the output source of electromagnetic waves can be irradiated to the irradiated object using the electromagnetic wave input/output element, and after receiving the reflected waves therefrom, signal detection, imaging, etc. can be performed using the first electromagnetic wave detecting unit.

In one embodiment, the fourth port of the coupler is connected to the second electromagnetic wave detecting unit.

According to this embodiment, the reflected wave signal from the irradiated object can be detected using the first electromagnetic wave detecting unit, while the electromagnetic wave signal generated at the output source of electromagnetic waves can be detected using the second electromagnetic wave detecting unit.

In one embodiment, the first electromagnetic wave detecting unit and/or the second electromagnetic wave detecting unit is connected to a cancellation system that cancels the output variation of the output source of the electromagnetic wave or an offset unit including a squaring system that superimposes the output of the electromagnetic wave output source.

According to this embodiment, a more accurate detection result can be obtained because the reflected wave signal from the irradiated object and the electromagnetic wave signal generated by the output of the output source of electromagnetic waves can be compared and processed.

The disclosure has been described above on the basis of examples. It is understood by those skilled in the art that the examples are illustrative and that various variations are possible in the combination of their respective components and respective processing processes, and that such variations are also within the scope of the present disclosure.

### (Variant 1)

The above description focused on an example in which the electromagnetic wave input/output element of the embodiment is applied as an imaging element. However, the electromagnetic wave input element is not limited to an imaging element and may be used as an antenna, for example.

According to this variant, the degree of freedom of use can be improved.

### (Variant 2)

In the first embodiment described above, the dielectric cube 10 is formed of PTFE. However, not limited to this, the dielectric cube 10 may be formed of any suitable material, for example, a resin with low dielectric loss at high frequencies. Here, acrylic is discussed as one such alternative material and compared to PTFE.

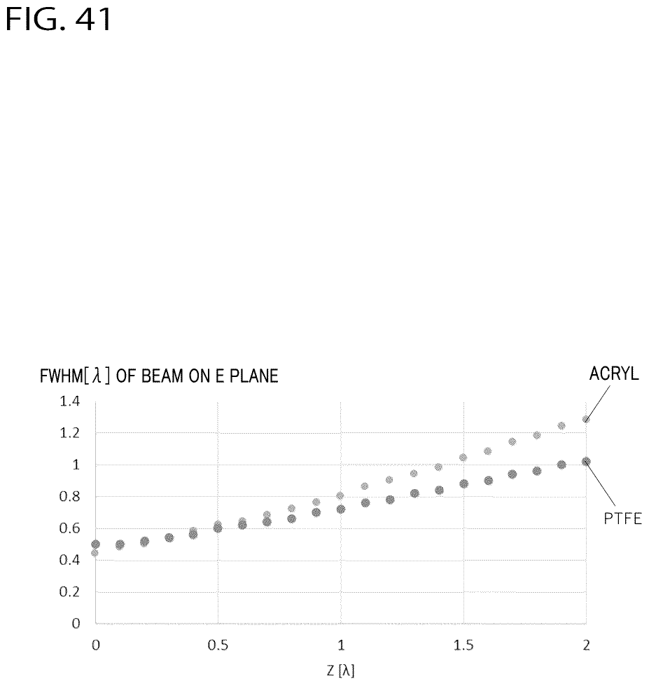

FIG. 41 shows the dependence of the FWHM of an electromagnetic wave beam generated by PTFE and acrylic dielectric cubes on the propagation distance in the E plane.

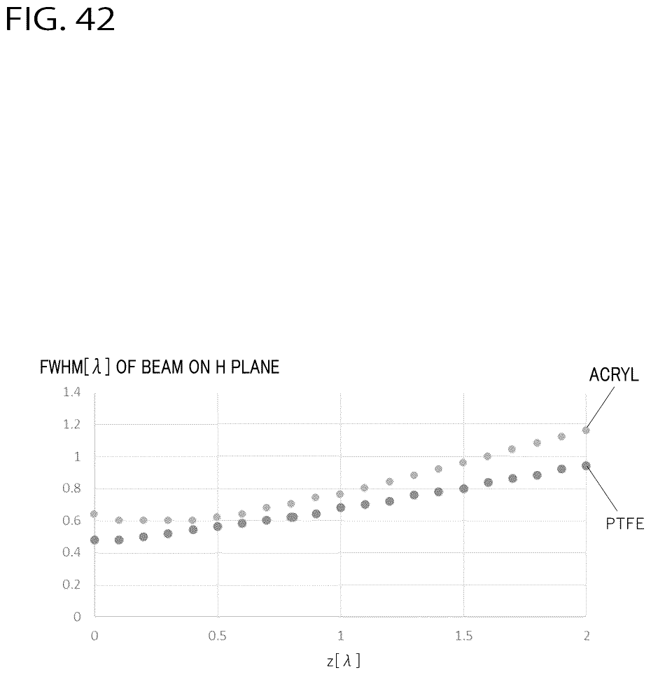

FIG. 42 shows the dependence of the FWHM of an electromagnetic wave beam generated by PTFE and acrylic dielectric cubes on the propagation distance in the H plane. The dielectric constant of PTFE at 300 GHz is 2.0. On the other hand, the dielectric constant of acrylic at 300 GHz is 2.59.

As shown in FIGS. 41 and 42, the acrylic dielectric cube can input and output electromagnetic beams with a beam width of about one wavelength order in the region from the surface to about two wavelengths, although the resolution is slightly lower than that of PTFE.

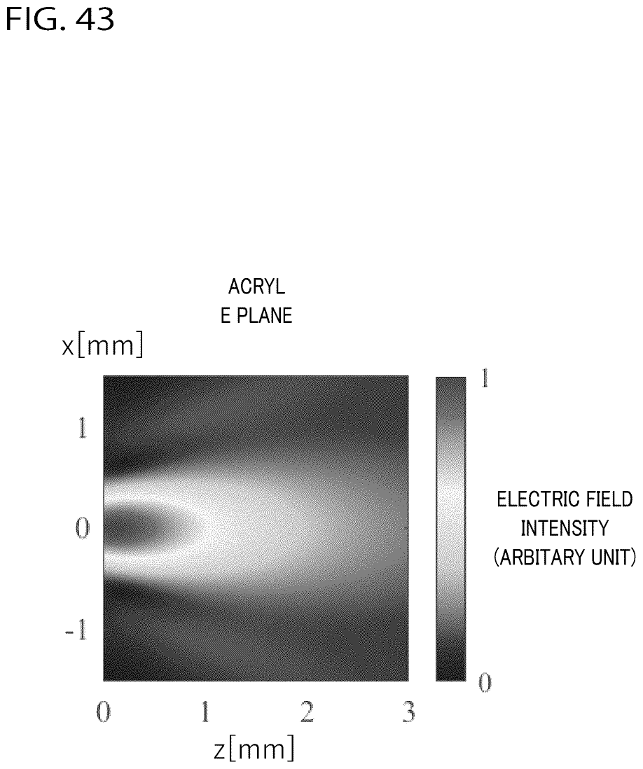

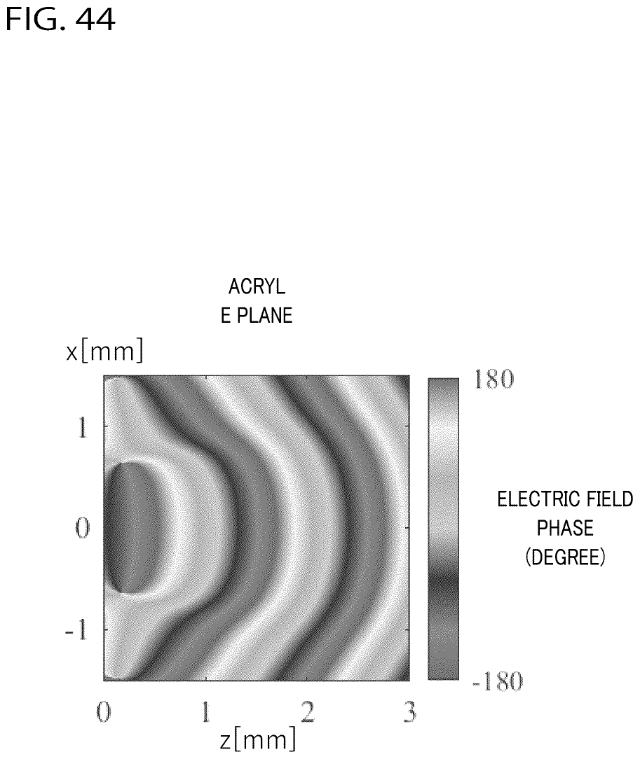

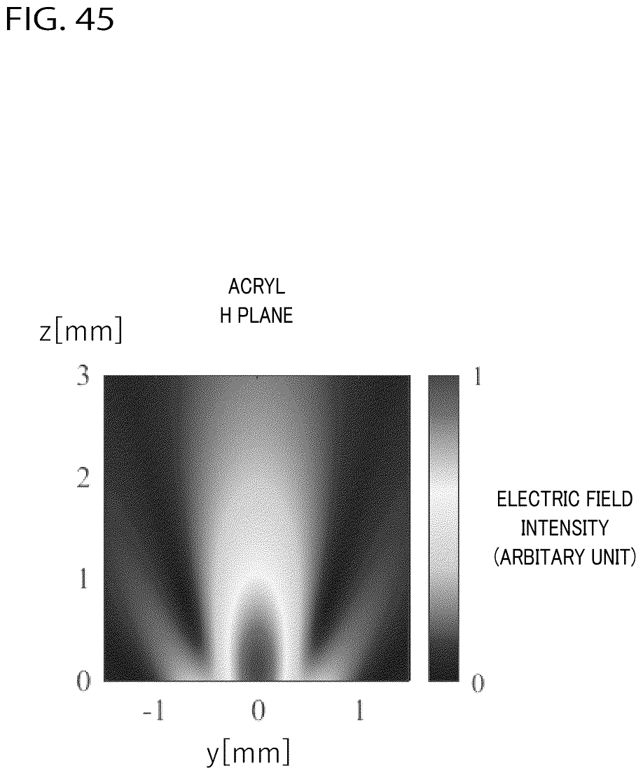

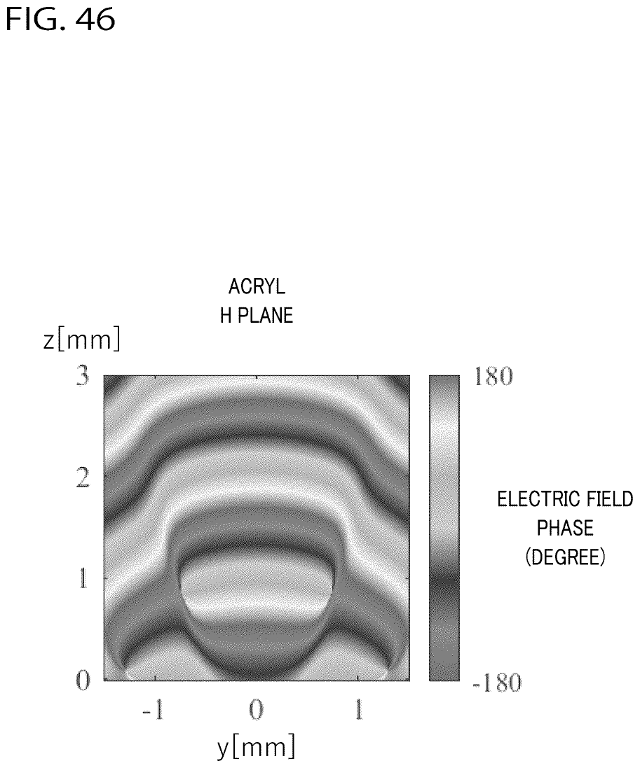

FIG. 43 shows the intensity distribution of the electric field in the E plane of an electromagnetic wave beam generated by the acrylic dielectric cube. FIG. 44 shows the phase distribution of the electric field in the E plane of an electromagnetic wave beam generated by the acrylic dielectric cube. FIG. 45 shows the intensity distribution of the electric field in the H plane of an electromagnetic wave beam generated by the acrylic dielectric cube. FIG. 46 shows the phase distribution of the electric field in the H plane of an electromagnetic wave beam generated by the acrylic dielectric cube.

According to this variant, the degree of freedom in the configuration can be improved.

Any combination of the above mentioned embodiments and variants is also useful as an embodiment of the present disclosure. The new embodiments resulting from the combination will have the combined effects of each of the embodiments and variations combined.

The above is a description of the embodiments and variations. In understanding the technical ideas abstracted from the embodiments and variations, the technical ideas should not be interpreted as limited to the contents of the embodiments and variations. The aforementioned embodiments and variations are merely concrete examples, and many design changes, such as changes, additions, and deletions of components, are possible. In the embodiments, the contents where such design changes are possible are emphasized with the notation “embodiments”. However, design changes are also permitted for contents without such notation.

### Industrial Applicability

The present disclosure is particularly useful for use in the following fields. However, it is not limited to this, and can be widely applied, especially in imaging. Imaging in non-destructive testing in general. Detection of weapons concealed in clothing or bags. Detection of banned drugs sealed in envelopes, etc. Infrastructure maintenance and inspection of bridges, tunnels, etc.

Mobile inspection systems on drones and vehicles.

### Reference Signs List

1 Electromagnetic wave input/output element,
2 Electromagnetic wave input/output head,
3 Electromagnetic wave input/output head,
4 Electromagnetic wave input/output head,
5 Electromagnetic wave input/output head,
10 Dielectric cube,
20 Protrusion,
30 Coupler,
31 Coupler,
40 the output source of electromagnetic waves,
50 First electromagnetic wave detecting unit,
60 Second electromagnetic wave detecting unit,
70 Offset unit,
100 Waveguide,
P1 First port,
P2 Second port,
P3 Third port,
P4 Fourth port.

1. An electromagnetic wave input/output element attachable to a waveguide, comprising:
a dielectric three dimensional object in the shape of a parallelepiped,
wherein the ratio b/c of the length b of the long side of the aperture surface of the parallelepiped and the length c of the side of the parallelepiped in the direction perpendicular to the aperture surface is smaller than 0.75.

2. The electromagnetic wave input/output element according to claim 1,
wherein the parallelepiped is rectangular parallelepiped.

3. The electromagnetic wave input/output element according to claim 1,
wherein the ratio b/c is 0.6 or less.

4. The electromagnetic wave input/output element according to claim 1,
wherein the ratio b/c is 0.4 or less.

5. The electromagnetic wave input/output element according to claim 1,
wherein the dielectric three dimensional object contains fluorinated resin in the material.

6. The electromagnetic wave input/output element according to claim 1,
wherein the surface opposite the aperture surface has a protrusion with a tapered tip for attachment to a waveguide.

7. The electromagnetic wave input/output element according to claim 1,
wherein the electromagnetic wave is microwave, millimeter wave or terahertz wave.

8. An electromagnetic wave input/output element attachable to a waveguide, comprising:
a three dimensional object in the shape of a parallelepiped with at least one of its sides truncated,
wherein the ratio b/c of the length b of the long side of the aperture surface of the three dimensional object and the length c of the side of the three dimensional object in the direction perpendicular to the aperture surface is 0.75 or less.

9. An electromagnetic wave input/output head, comprising:
a coupler having at least three ports; and
an electromagnetic wave input/output element forming a parallelepiped,
wherein the electromagnetic wave input/output element is attached to the first port of the coupler.

10. The electromagnetic wave input/output head according to claim 9,
wherein the second port of the coupler is connected to an output source of electromagnetic waves and the third port is connected to the first electromagnetic wave detecting unit.

11. The electromagnetic wave input/output head according to claim 10,
wherein the fourth port of the coupler is connected to the second electromagnetic wave detecting unit.

12. The electromagnetic wave input/output head according to claim 11,
wherein the first electromagnetic wave detecting unit and/or the second electromagnetic wave detecting unit is connected to a cancellation system that cancels the output variation of the output source of the electromagnetic wave or an offset unit including a squaring system that superimposes the output of the electromagnetic wave output source.
